(19) United States
(12) Patent Application Publication
(10) Pub. No.: US 2024/0251994 A1
(43) Pub. Date: Aug. 1, 2024

(54) PRECISION CONTROL FOR HEATING APPLIANCE

(71) Applicant: SPECTRUM BRANDS, INC., Middleton, WI (US)

(72) Inventors: Boopalan Sampath, Madison, WI (US); Lewis A. Lartey, Madison, WI (US); Kevin B. Kinney, Waunakee, WI (US); Michael S. Rubrich, Sun Prairie, WI (US); Kroy Everett Nernberger, Middleton, WI (US); Peter Alan Steiner, Madison, WI (US); Cole Salek, Middleton, WI (US)

(21) Appl. No.: 18/566,340

(22) PCT Filed: Jun. 1, 2022
(86) PCT No.: PCT/US2022/031804

§ 371 Date: Dec. 1, 2023

Related U.S. Application Data
(60) Provisional application No. 63/195,745, filed on Jun. 2, 2021.

(51) Int. Cl. A47J 37/08

(52) U.S. Cl. CPC A47J 37/085

(57) ABSTRACT

A method of controlling a heating appliance includes receiving a level selection at a controller, reading a starting parameter at an initiation of a heating process and providing a signal to the controller, accessing a memory including a matrix of heating parameters, selecting a first group of equations of the matrix at the controller based on the selected level, where the first group of equations include at least a first equation and a second equation corresponding to first and second starting parameter ranges, identifying an equation of the first group of equations of the matrix at the controller, the matrix having a corresponding starting parameter range based on the starting parameter, and performing the heating process according to the identified equation.

### CROSS REFERENCE TO RELATED APPLICATIONS

This application claims priority to and the benefit of U.S. Provisional Patent Application No. 63/195,745, filed Jun. 2, 2021, the entire contents of which is incorporated herein by reference in its entirety.

### FIELD

The present application relates to electric appliances, and more particularly to heating appliances with improvements to physical arrangements, sensing, and control aspects thereof.

### BACKGROUND

Heating appliances typically utilize electrical heating elements for cooking or otherwise heating food items, such as breads, pastries, vegetables, meats, and the like. Other, non-food items can also be heated using heating appliances, Certain appliances utilize time-based heating cycles that depend on a selected, target parameter, such as level settings (e.g., light or dark shade). However, a universal target parameter level and shade setting can be imprecise when different types of items to be heated are introduced to the appliance for a given setting. Additional factors can also make precise heating control challenging, such as freshness, age, moistness/dryness, thickness, or origin of the item or food product, and other ambient heating conditions within the appliance or experienced by the appliance. For example, whether or not the appliance is still warm from a previous usage or is fully at ambient temperature can affect heating conditions and control. Guesswork by the user has therefore been required, including to compensate for numerous toasting or heating variables in order to achieve a desired heated item consistency, color, texture, and the like.

Temperature sensors have been incorporated into designs of heating appliances such as toasters. Challenges exist relating to sensor type and placement and type. Existing heating appliances such as toasters have utilized bimetallic strips or other mechanical sensors. Existing appliances also can have reduced precision and additional challenges for toast shade when repeated heating cycles are performed consecutively. Difficulties can occur when the heating cavity starts with residual heat from the previous heating cycle. For example, it can be difficult for an appliance on repeated heating cycles to achieve a consistent toasting result for each heating cycle. There is therefore a need to devise improved appliance heating control and sensor arrangements to provide easy-to-use, repeatable, and predictable heating performance in a wide variety of conditions.

### SUMMARY

The present application relates to user-friendly improvements and precision control for heating appliances, such as detecting a starting ambient temperature within an appliance and a target parameter (e.g., shade or doneness) level or setting and conducting a heating process in accordance with the parameter setting and detected conditions based on a selection table. As disclosed herein, precision, selection table-based, control techniques can be implemented in which a heating cycle can be streamlined and additional functions can become optional, such as frozen mode and the like as the appliance is able to seamlessly adjust the heating cycles according to food item conditions and characteristics for a given parameter setting. Preferably, according to the precision control techniques described herein, when a surface of a food item reaches a certain temperature, the heating process stops. For some food items, the surface temperature of the food item can correspond and correlate to a desired target parameter level of the food item (e.g., toast shade). Surface temperature is one example, but any sensed food item property, or combination thereof can be used herein. Therefore, this relationship with a properly positioned electronic sensor permits a closed feedback loop where the heating cycle ends when the precise desired parameter (e.g., shade) is achieved from the heating cycle. Rate of change of sensed temperatures at various sensors can further be utilized to determine more precise conditions to yet further refine various embodiments herein.

Also disclosed herein is improved sensor placement for detecting heat or other parameter conditions within a heating appliance such as a toaster, e.g., near a food item to be heated. By implementing the improvements disclosed herein, there is an improved ability to achieve desired parameter (e.g., doneness) characteristics across different food types. For instance, if a user desires a consistent golden brown toast shade result, a particular shade set point can be set and left on the heating appliance for various types of food products and breads and a consistent shade will be achieved for each type of food product. For example, sourdough and multigrain bread can take longer to toast than white or wheat breads for a certain selected parameter and shade level.

According to a first aspect of the present disclosure, a heating appliance is disclosed. According to the first aspect, the heating appliance includes a heat source supported by a housing, the heat source operatively connected to a power supply. The heating appliance also includes a food guide element operatively supported by the housing, the food guide element including at least one guide wire positioned in a first orientation. The heating appliance also includes a sensor attached to the guide wire such that the sensor at least partially overlaps a surface of the guide wire.

According to a second aspect of the present disclosure, a method of controlling a heating appliance is disclosed. According to the second aspect, the heating appliance including a housing, a food support operatively connected with a housing, a heating source, and a controller. According to the second aspect, the method includes receiving a level selection at the controller. The method also includes reading a starting parameter at an initiation of a heating process and providing a signal to the controller. The method also includes accessing a memory at the controller, the memory including a matrix of heating parameters. The method also includes selecting a first group of equations of the matrix at the controller based on the selected level, the first group of equations including at least a first equation and a second equation corresponding to first and second starting parameter ranges. The method also includes identifying an equation of the first group of equations of the matrix at the controller, the matrix having a corresponding starting parameter range based on the starting parameter. The method also includes performing the heating process according to the identified equation.

According to a third aspect of the present disclosure, a heating appliance is disclosed. According to the third aspect, the heating appliance includes a hardware processor operatively coupled to a memory, where the hardware processor is configured to execute steps. According to the third aspect, the steps include receiving a level selection. The steps also include receiving an indication that a heating process is starting. The steps also include reading a starting parameter. The steps also include accessing a memory including a matrix of heating parameters. The steps also include selecting a first group of equations of the matrix based on the selected level, the first group of equations including at least a first equation and a second equation corresponding to first and second starting parameter ranges. The steps also include identifying an equation of the first group of equations of the matrix having a corresponding starting parameter range based on the starting parameter. The steps also include performing the heating process according to the identified one equation.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of a heating appliance, according to various embodiments,

FIG. 2 is a top view of the heating appliance of FIG. 1, according to various embodiments.

FIG. 3 is a partial cross-section view of certain internal components of the heating appliance of FIG. 1, according to various embodiments.

FIG. 4 is another partial cross-section view of certain internal components of the heating appliance of FIG. 1, according to various embodiments.

FIG. 5 shows various components of the heating appliance of FIG. 1 in more detail, according to various embodiments.

FIG. 6 is another view of the components of FIG. 5, according to various embodiments.

FIG. 7 is a close-up view of certain components related to a sensor for use with the heating appliance of FIG. 1, according to various embodiments.

FIG. 8 is another close-up view of certain components related to the sensor for use with the heating appliance of FIG. 1, according to various embodiments.

FIG. 9 is yet another close-up view of certain components related to the sensor for use with the heating appliance of FIG. 1, according to various embodiments.

FIG. 10 is a flowchart for a process of heating a food item with a heating appliance using a selection table, according to various embodiments.

FIG. 11 is a time vs. temperature chart for an ambient start of a heating appliance, according to various embodiments.

FIG. 12 is a time vs. temperature chart for a hot start of a heating appliance, according to various embodiments.

FIG. 13 is an example correspondence table of target temperature for a food item after heating using a heating appliance compared to starting temperature.

FIG. 14 is a graph showing a relation of starting temperature to desired final temperature according to a piece-wise function and a selected toasting shade level, according to various embodiments,

FIG. 15 is a chart showing example quadratic and linear equations for a given toasting shade level, according to various embodiments.

FIG. 16 is a chart showing an example time-based equation for various toasting shade levels, according to various embodiments.

FIG. 17 is an example partial selection table matrix for selected toasting shade levels, according to various embodiments.

FIG. 18 is a schematic diagram of an example heating appliance, according to various embodiments.

FIG. 19 shows a summary of cycle variation data for a time-based only toasting with a fixed starting condition compared to a disclosed selection table heating method for all starting conditions, according to various embodiments.

FIG. 20 shows additional summary data of cycle variation data for a time-based only toasting with a fixed starting condition compared to a disclosed selection table method with all starting conditions, according to various embodiments.

FIG. 21 is a data table with quantitative shade values for a disclosed selection table method for various shade levels, according to various embodiments.

FIG. 22 shows shade values and images for disclosed selection table method testing for quadratic and linear portions of a piece-wise function for an example shade level 6, according to various embodiments.

FIG. 23 shows shade values and corresponding images for the disclosed selection table method testing for time-only portion of a piece-wise function for an example shade level 6, and average and standard deviation of the test data, according to various embodiments.

FIG. 24 shows shade values and corresponding images for disclosed selection table method testing for quadratic and linear portions of a piece-wise function for an example shade level 4, according to various embodiments.

FIG. 25 shows shade values and corresponding images for disclosed selection table method testing for a time-only portion of a piece-wise function, for an example shade level 4, and average and standard deviation values of the test data, according to various embodiments.

FIG. 26 shows shade values and corresponding images for disclosed selection table method testing for quadratic and linear portions of a piece-wise function, for an example shade level 3, according to various embodiments.

FIG. 27 shows shade values and corresponding images for disclosed selection table method testing for time-only portion of a piece-wise function, for an example shade level 3, and average and standard deviation of the test data, according to various embodiments.

FIG. 28 shows baseline testing data for time-based only control.

FIG. 29 shows testing data for disclosed selection table method using a piece-wise function, according to various embodiments.

FIG. 30 is a comparison of ambient start shade data and corresponding images for example shade 6 for disclosed selection table method toasting and time-based only toasting.

FIG. 31 is a comparison of hot start shade data and corresponding images for example shade 6 for disclosed selection table method toasting and time-based only toasting.

FIG. 32 shows numerical data for average difference and cumulative data between ambient and hot starts for existing time-based only and disclosed selection table method examples for shade level 6.

FIG. 33 is a comparison of ambient start shade data and corresponding images for example shade 4 for disclosed selection table method and time-based only toasting.

FIG. 34 is a comparison of hot start shade data and corresponding images for example shade 4 for disclosed selection table method and time-based only toasting.

FIG. 35 shows numerical data for average difference and cumulative data between ambient and hot starts for existing and disclosed selection table method toasting examples for shade level 4.

FIG. 36 is a comparison of ambient start shade data and corresponding images for example shade level 3 for disclosed selection table method and time-based only toasting,

FIG. 37 is a comparison of hot start shade data and corresponding images for example shade level 3 for disclosed selection table method and time-based only toasting.

FIG. 38 shows numerical data for average difference and cumulative data between ambient and hot starts for existing and disclosed selection table method examples for example shade level 3.

FIG. 39 shows an example general format of toasting time equations for use in various optional embodiments that use maximum and minimum time limits for a toasting cycle.

FIG. 40 is a flowchart for an example selection table method control logic for use with a heating appliance controller, according to various embodiments.

FIG. 41 shows example selection tables for use with the control logic of FIG. 40, according to various embodiments.

FIG. 42 graphically shows an embodiment of the present disclosure that utilizes optional minimum and maximum heating appliance run times for an example shade setting for a heating cycle.

FIG. 43 shows a correspondence for a time-only based portion of a selection-table method, including a correspondence between run time and starting temperature for a hot start as further utilizing a time-derivative function based on a sensed temperature at example shade level 4.

FIG. 44 is an example of temperature vs. time data associated with a heating appliance that is cooling at a point in time as determined at a sensor.

FIG. 45 is an example of temperature vs. time data associated with a heating appliance that is heating at a point in time as determined at a sensor.

### DETAILED DESCRIPTION

The methods and features described herein are applicable to heating appliances, and more particularly to heating appliances including electrically-powered and controlled “pop-up” toasters, toaster ovens, grills, and container cookers, among other appliances.

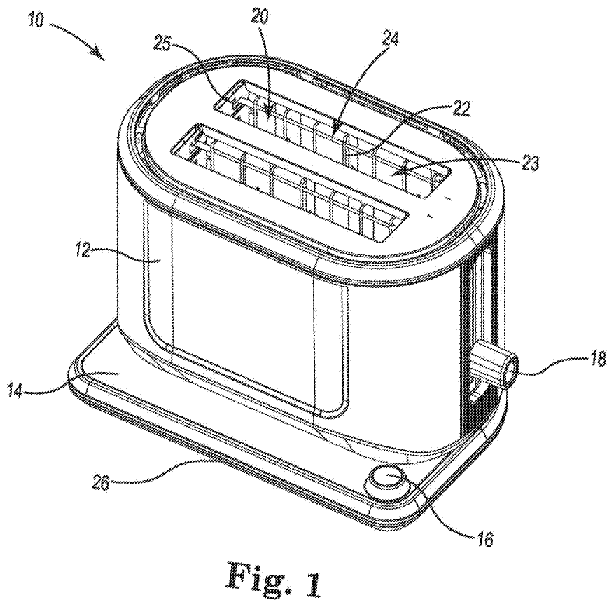

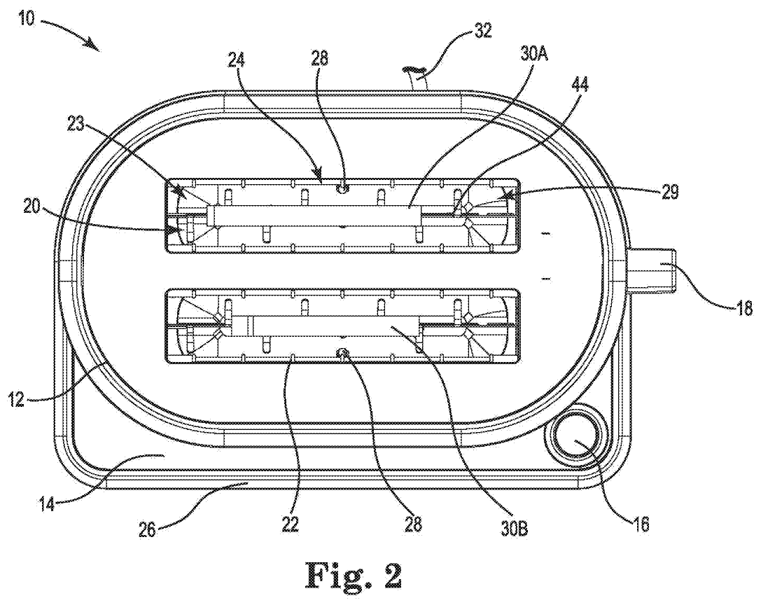

An example heating appliance (e.g., a toaster) 10 is shown with reference to FIG. 1. As shown, the example heating appliance 10 has a base portion 26 that supports a generally vertically extending chassis in the form of housing 12. The housing 12 has an upper end, and one or more side portions as shown. At an upper end of the housing 12 are one or more open slots 20 that define respective openings configured to each receive one or more food items 30 as desired. At one side portion of the housing 12 is a vertically-movable lever 18 that is operatively connected to a carriage 44. The lever 18 rests in an uppermost position when the heating appliance 10 is not in use. When the lever 18 is lowered, the carriage 44 lowers in accordance with the lever 18. The lever is therefore used to lower a food item 30 (see FIG. 2) in order to begin a heating cycle or the like. The carriage 44 preferably at least partially vertically supports the food item 30 in the shown embodiment. Other embodiments (not shown) support the food in a horizontal, tray or rack orientation (e.g., as in a toaster oven) or in any other suitable orientation or manner.

With reference to FIG. 2, the one or more open slots 20 of the housing 12 are configured to receive food item(s) 30. Each open slot 20 and the housing 12 preferably defines a heating cavity 23 that houses the movable carriage 44 and one or more food guides 24, also referred to herein as bread guides 24. As shown each heating cavity 23 is open, while in other embodiments each heating cavity 23 can be enclosed, such as by a door in a toaster oven. As shown, each bread guides 24 can comprise a structure of horizontal and vertical wires 22 and 48/50 arranged to provide a food product side support and are preferably provided in opposed pairs referred to collectively or individually as a guide assembly or assemblies 29 that can operate to support the food item 30 from two sides in coordination. In some embodiments, the two or more bread guides 24 are operatively connected directly or indirectly to the lever 18 and/or the carriage 44 such that the bread guides 24 are horizontally movable in tracks 25 in response to the lever 18 being depressed. Other embodiments omit the movable lever 18 and carriage 44, such as in a toaster oven type embodiment with a generally horizontal orientation and tray or grille-type support for the food item 30.

As shown, the guide assemblies 29 are fixed vertically so that the carriage 44 is positioned between the opposed guides 24 to move vertically with lever 18. A surface 14 of the base portion 26 can optionally support one or more controls, such as knob 16 and/or various touch controls that can be used to, e.g., select a desired toast shade or other setting, select a bagel mode, a defrost mode, or the like. At least one temperature sensor 28 is preferably provided and supported within heating appliance 10 as shown in FIGS. 2-4. A lower shield 46 (e.g., a heat reflecting shield) can be non-movable and positioned at a lower end of housing 12. The heating appliance 10 can be wired to a power source via a power cord 32 (FIG. 2), or can include its own power source, such as a battery or the like, in other embodiments.

As shown, each heating cavity 23 comprises a guide assembly 29 including two guides 24. In some embodiments, two or more heating cavities 23 can be a single heating cavity 23; in other embodiments the heating cavities 23 can be at least partially separated by various barriers, etc. Each heating cavity 23 can be provided with a respective sensor 28. The carriage 44 is vertically movable according to the lever 18 being lowered or raised. When the carriage 44 is raised, it supports and causes the food item 30 to be raised with the carriage 44 while the bread guides 24 maintain a fixed vertical position. In preferable embodiments, the guides 24 of the assembly 29 can move horizontally according to a food item 30 width, e.g., upon starting or ending a heating cycle. As shown in FIG. 1, preferably a pair of horizontal linear tracks 25 permit each guide 24 of the assembly 29 to move or pivot in a substantially horizontal direction. The tracks 25 operate by providing a guiding slot to receive a portion of the bread guide 24 such that the portion slides along the track 25 for a preset innermost and outermost (resting) position when a movement causing input is received, e.g., from the action of the lever 18 and/or carriage 44. The tracks 25 preferably allow the bread guides 24 to move according to a width of the food item 30 and along a distance defined by the track 25. The carriage 44 and bread guides 22 preferably individually or collectively support the food item 30. Two selected example sizes of the food item 30 are shown in FIG. 2, including a first, longer food item 30A and a second, shorter food item 30B. Any suitable size or shape food item 30 can be received within the guide assembly 29 and heating cavity 23 of the heating appliance 10 according to the dimensions of open slot 20 and/or guide assembly 29 configuration.

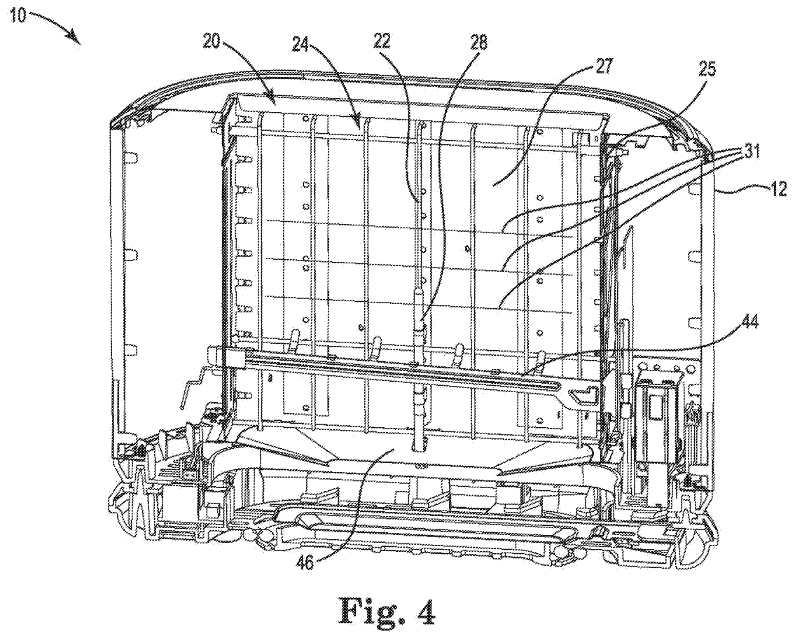

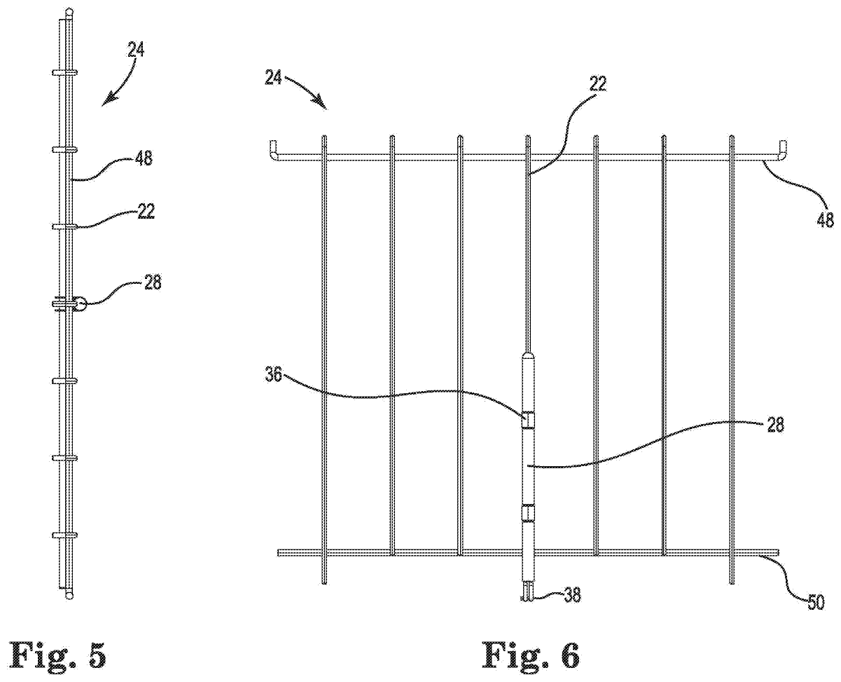

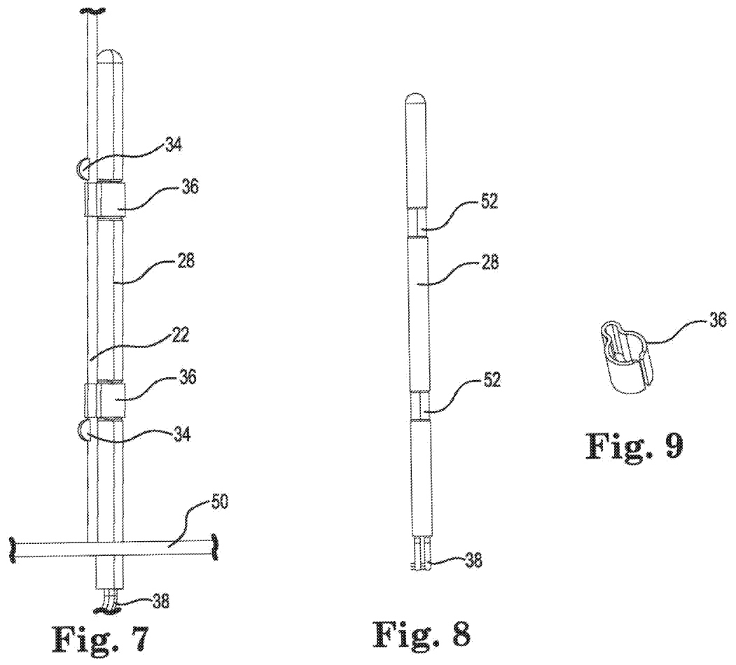

As shown with reference to the example heating appliance 10 of FIGS. 5-8, a plurality of guide wires 22 of the guide 24 can be oriented in a first orientation (e.g., vertically), and together with horizontal wire upper and lower cross-members 48 and 50, respectively, can define each grille-like bread guide 24 of the guide assembly 29. In other embodiments, the guide wires 22 and guide 24 can be generally oriented horizontally (e.g., as one or more guides or support racks), at an angle, or any other suitable variation. The sensor 28 can be generally elongated and cylindrical, and as shown in FIGS. 7 and 8, can be closely positioned against a guide wire 22, e.g., a central guide wire 22 of a guide 24. Therefore, as shown, the sensor 28 is at least partially overlapping a portion of the guide wire 22, and only minimally blocking direct heating produced by a heat source such as one or more heating elements 31 of the heating card 27 (see FIG. 4) from reaching the food item 30.

As shown in FIGS. 5 and 6, the sensor 28 can be attached to a wire 22 of the guide 24. The sensor 28 can be positioned in a first orientation, such as a generally vertical orientation as shown. Alternatively, the sensor 28 can be positioned in a horizontal orientation (e.g., mounted at least partially perpendicular to the orientation of the vertical guide wires 22 or on a tray of a toaster oven as an example of a heating appliance). The sensor 28 is preferably configured to be attached to the guide wire 22 in the same, first (vertical) orientation such that the sensor at least partially overlaps a surface of the guide wire 22, although other orientations, such as at least partially perpendicular to the guide wire 22 is also contemplated. In preferable embodiments, when the sensor 28 is attached to the guide wire 22, the sensor 28 directly contacts the guide wire 22 along a length, e.g., a portion of or an entire length of the sensor 28. In other preferable embodiments, the sensor 28 in a horizontal orientation contacts the guide wire(s) 22 at one or more points of one or more of the perpendicularly-oriented guide wire(s) 22.

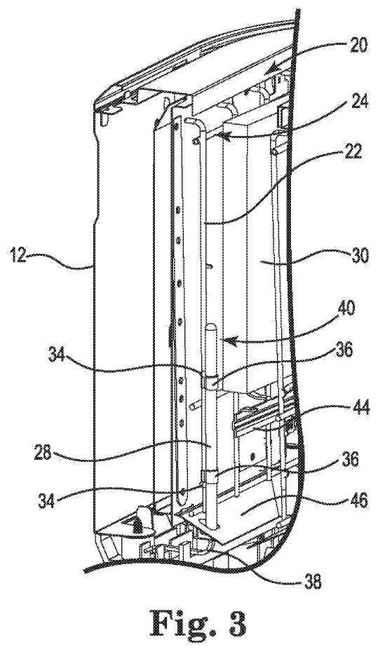

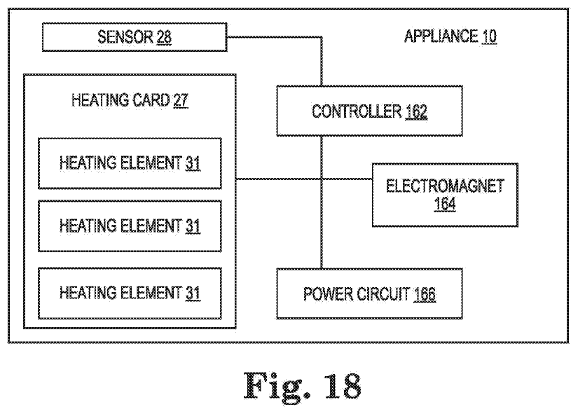

The sensor 28 can be electronic and attachable to a guide wire 22 and thus preferably supported by a guide 24. A shown in FIG. 3, the sensor 28 can be operatively connected to a controller (not shown, see, e.g., controller 162 of FIG. 18) via an electrical connection 38, When the lever 18 is depressed/lowered, the carriage 44 is also lowered accordingly and can also cause the guides 24 of the guide assembly 29 to contact and hold the food item 30 for a secure and consistent positioning during heating. The positioning preferably is defined as a closely-spaced relationship of distance 40 (see FIG. 3) of a food item 30 from the sensor 28.

For example, the distance 40 can be close enough for a food item 30 surface temperature to influence a reading at the sensor 28, and preferably far enough from the food item 30 for even heating of the food item 30 behind the sensor 28. In one example embodiment, the distance 40 is on the order of about 1-5 mm. the guides 24 pivot according to tracks 25, with the sensor 28 mounted are substantially a lower portion of a guide 24 opposite the tracks 25 located at an upper portion of the guide 24, a spacing is preferably maintained even as the guides 24 hold the food item 30.

Preferably, as shown, the sensor 28 does not contact the food item 30 during operation. For example, contact of the sensor 28 to the food item 30 would potentially lead to less evenness and/or blocking of at least some heat reaching the food item 30 surface without an adjustment to heating parameters. Furthermore, in various embodiments the sensor 28 (or combination of two or more sensors 28) can be configured to determine a physical distance of the food item 30 from the sensor 28 or any other reference object within the heating appliance 10. In various embodiments, the sensor 28 can be configured to detect any contact with the food item 30, and can, for example, send a message to a controller to indicate that presence of contact, A heating cycle or parameters thereof can optionally be adjusted in response to receiving an indication of food item 30-to-sensor 28 contact. In some embodiments, the controller can select a different equation, set of equations, sub-equation, or the like based on a determination that the sensor 28 is in contact with the food item 30. If a set of contact-based equation(s) are selected, target temperatures and end temperature values can in some cases default to a time-based only heating cycle based on the indication that the contact has occurred in order to avoid relying on sensed temperature data in such a situation.

As shown best in FIG. 7, at least one wire 22 of the bread guide 24 preferably includes one or more alignment protrusions 34 that are spaced for precise positioning of the sensor 28 on the wire 22. One or more corresponding clips 36 can be shaped to removably grip and hold the sensor 28 to the wire 22 with a biasing spring action. The clips 36 can be compliant and can include spring-like features. Alternatively, the clips 36 can be welded directly to the wire 22 or optionally formed integrally together. Furthermore, any fastening arrangement or method can be utilized to reduce or prevent relative motion between the sensor 28 and the wire 22 of the bread guide 24. An example clip 36 is shown in FIG. 9. As shown in FIG. 8, the sensor 28 preferably has one or more indentations 52 along its length sized and shaped to receive the corresponding clips 36 when fully assembled and attached to wire 22. As shown and when assembled, the sensor 28 can extend beyond (above and below) the tipper and/or lower cross members 48, 50 of the guide 24, respectively. As shown in particular with reference to FIG. 4, the sensor 28 can be positioned such that it at least partially passes through a lower shield 46 that is supported by the housing 12. The sensor 28, when assembled, can pass through a portion of the lower shield 46 to reduce heat exposure of operative connecting wires of the sensor 28 to excessive heat during operation. As also shown in FIG. 4, the carriage 44 when in a fully lowered (ready for heating) position can be generally located above and proximate the lower shield 46 and sensor 28.

Optionally, one or more shields (e.g., thermal, electromagnetic, sonic, etc.) or other reflective devices can be provided within heating cavity 23 to enable the sensor 28 to better measure a detected parameter (e.g., surface temperature) of the food item 30. Various shields can be composed of metal or any other suitable composition. Lower shield 46 is one possible example of such a reflective device. The sensor 28 can be placed positioned in a variety of locations within the heating cavity 23. In preferable embodiments, each heating cavity 23 of the heating appliance 10 is provided with a sensor 28. Preferably, the sensor 28 is mounted to a bread guide 24 so that it is positioned proximate the surface of the food item 30. In various embodiments, a bread guide 24 to which the sensor 28 is mounted can be positioned at an angle relative to vertical. Based on the angle of the bread guide 24, a top of the bread guide 24 can contact the food item 30 and a lower portion of the same bread guide 28 can be progressively further spaced from the food item 30, which can be optionally compressible. In this way, wires 22 of the bread guide 24 can be more spaced from the food item 30 at the lower portion. In various embodiments and based on the above, the sensor 28 is preferably placed at a location on the wire(s) 22 such that a desired distance from the food item 30 to the sensor 28 is achieved, e.g., for an intended type of food item 30 (e.g., typical sliced bread and the like). Nevertheless, it is contemplated that there remains at least some degree of variability and/or uncertainty and that in some cases contact between sensor 28 and food item 30 can occur, e.g., if the food item 30 is unusually thick or inserted with a tilt or the like. Alternatively, the sensor 28 could be mounted to the heating card 27 or housing 12 of the heating appliance in any location that allows the sensor 28 to read, receive, or otherwise determine at least the surface temperature of the food item 30. In various embodiments, the sensor 28 can determine a non-surface (e.g., internal) temperature of the food item 30, and as described above can further detect sensor 28-to-food item 30 contact.

The sensor 28 can be a thermal sensor in some examples. Examples of thermal sensors include a negative temperature coefficient (NTC) sensor, thermocouple, a resistance temperature detector (RTD), or other electronic sensor, according to various embodiments. In some optional embodiments, the sensor 28 is an infrared thermometer that measures the surface temperature of the food item 30 using infrared radiation (IR). In various embodiments (e.g., where the sensor 28 is an IR sensor), the sensor 28 can be positioned in any suitable location(s) in order to directly or indirectly determine a surface temperature (or other parameter) of the food item. In various embodiments the IR sensor is positioned at a distance from a food item 30 to be heated, e.g., in a toaster oven embodiment. In various other embodiments, the sensor 28 can be positioned proximate a food item 30 to be heated for more direct sensing of surface temperature of the food item 30 during heating. In the case of an NTC sensor 28, a position of the sensor 28 closer to a food item 30 can cause a sensed temperature to be sufficiently influenced by the surface temperature of the food item 30, and correspondingly less sensed from the cavity 23 surrounding the food item 30. As the food item 30 is being heated and the surface temperature of the food item 30 being monitored, sufficient influence on the sensor 28 from the food item 30 can enable a closed feedback loop at a controller such that a desired surface temperature, level, or other parameter level can be achieved.

In some embodiments, the sensor 28 is a sensor of a parameter other than temperature. The sensor 28 can be a humidity sensor (hygrometer) in some embodiments. The sensor 28 can alternatively or additionally be a light sensor, camera, photo diode, or an electromagnetic sensor of any kind, including a sensor configured to sense visible light, ultraviolet (UV) light, infrared light, etc. The sensor 28 can detect sound waves, smells, or detect particles, waveforms, or properties otherwise not listed above. Although various embodiments herein are directed to a single sensor 28 of a single parameter type, it is contemplated that more than one sensor 28 can be included such that one or more parameter types can be sensed within a heating appliance 10. In some embodiments, temperature or thermal aspects as described herein can be replaced or supplemented with humidity and/or light-based detection and parameter detection. For example, a heating appliance can detect humidity levels during heating in order to further refine a time needed to achieve a desired selection level (e.g., a toasting shade level), and visual aspects of a food item before or during heating can be used to further refine a heating process. In various embodiments, the sensor 28 can detect physical distances and/or relationships of various objects and/or components within the heating appliance 10, such as the contact of sensor 28 to food item 30 as described above.

In preferable embodiments, the sensor 28 and the parameter(s) sensed thereby is configured to allow the food item 30 to influence or have parameter(s) thereof detected by the sensor 28. Also in preferred embodiments, the sensed parameters are sufficient to achieve a desired output parameter so that a level or setting as desired can be achieved during heating. In yet further preferred embodiments, the sensor 28 is configured to resiliently withstand environmental conditions (such as heat) such that an accurate and useful output can be used to control heating. As one example, a thermal-sensing NTC sensor can be encapsulated in stainless steel for protection from heat while providing useful thermal sensing information for controlling heating. The sensor 28 can be protected from other of various other environmental conditions by any of various coatings, shields, and the like as suitable.

In cases where physical distance, e.g., of or relating to the food item(s) 30, is at least one parameter sensed by the sensor(s) 28, various features and conditions can be determined geometrically. For instance, the sensor 28 can operatively determine a thickness or size of the food item 30, the distance of the food item(s) 30 from one or more heating element(s) 31 of the heating card 27, and/or presence/location of the food item(s) 30 within the heating cavity 23. In various embodiments, the sensor 28 can incorporate an ultrasonic range sensor or the like. The heating appliance 10, when a distance and/or spatially-sensitive sensor 28 is used, can read physical distance and size parameters and use these parameters by way of a controller to select a cooking process or the like accordingly. Operation of the heating appliance 10 can be adjusted based on sensed physical distances, relationships, spacing, and/or detected sizes of the food item 30 in various embodiments. For example, if a food item 30 is positioned closer to a sensor 28, the sensor 28 may read a surface temperature of the food item 30 relatively more directly, and the sensor 28 may be less affected by other ambient factors of the cavity 23 and the like. Sensed spatial and geometric characteristics can be used to adjust any number of operation parameters of the heating appliance, including but not limited to: cavity 23 temperature monitoring, which heating elements 31 of the heating card 27 are energized, whether one of more fans are engaged, how long a heating cycle lasts, etc. Physical distance and size parameters within the heating appliance 10 may typically not change significantly over a heating process cycle, and therefore other parameters, such as heating time, energy used (including variable energy used and rates of change thereof relative to time), or other variables can be used to more directly determine when a heating cycle should end.

As shown in FIG. 4, each heating card 27 can include one or more preferably resistive heating elements 31. Although not shown, other types of non-resistive heating elements 31 are also contemplated herein. Each heating card 27 can be operatively connected to a controller and power circuit (not shown, see example power circuit 166 of FIG. 18) that are configured to provide electrical energy to the heating card 27 and heating elements 31 according to a desired heating cycle. A desired heating cycle can include powering the heating elements 31 of the heating card 27 at an energy level for an amount of time that is correlated to particular parameter levels (e.g., temperatures, including both starting and target temperatures). In some embodiments, the heating card 27 is energized at a set energy level (power usage) and a time of energizing the heating card 27 is adjusted. The controller can be configured to track and store information relating to energy used by the heating card 27. In other embodiments, the heating card 27 can be heated at an adjustable power level according to various factors, such as sensed conditions received at sensor 28. Embodiments herein contemplate heating the heating card 27 to a set or varied (including dynamically varied based on a controller output signal) power level and de-energizing the heating elements 31 after a time and/or condition is reached. In various embodiments, heating via the heating card 27 can be varied dynamically based on a primary selection or a secondary selection for a heating process based on a user selection or a selection made automatically. For example, for a given shade level (e.g., shade 4), the controller can utilize various dynamic heating programs based on various selections, including an “eco” mode, which can achieve shade 4 with less total power usage or the like. The controller can be any suitable type of microcontroller, application-specific integrated circuit (ASIC), or the like and can include at least a processor operatively coupled to a memory. Controller and microcontroller are therefore used interchangeably herein.

With example physical characteristics of the example heating appliance 10 now described, examples of heating processes to be conducted using the heating appliance 10 are discussed next. It is to be understood that the processes described below can be carried out by any type of heating appliance, toaster, or other electrical appliance. The heating appliance 10 as described above with reference to FIGS. 1-9 is one of many possible examples contemplated herein, and is intended for illustrative purposes only. Although a pop-up type toaster heating appliance 10 is shown with reference to the Figures above, additional types of heating appliances, such as toaster ovens, etc. are contemplated herein.

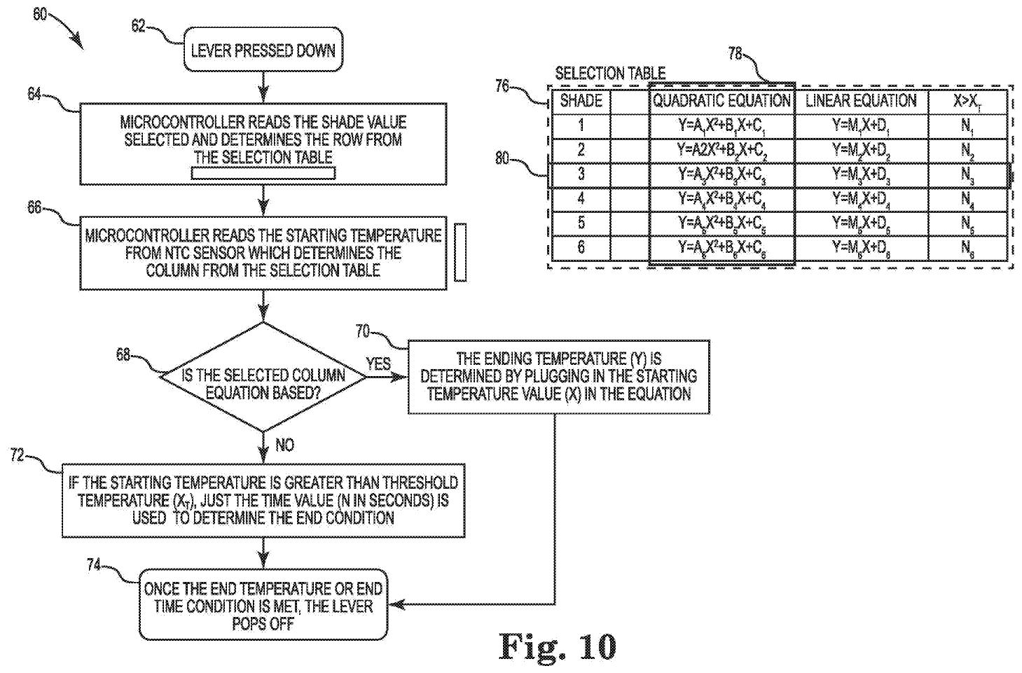

With reference now to FIG. 10, a representative selection table-based control process 60 is illustrated as an example flowchart. Process 60 can be performed by a controller as described herein. Process 60 shows precisely heating a food item 30 using a heating appliance 10, according to various embodiments. Process 60 illustrates one possible example of a selection table, and piece-wise function-based process for a heating cycle according to a starting temperature, a selected toast shade setting, and a piece-wise function based on both the starting parameter (temperature) and the selected toast shade setting to provide an optimized and repeatable heating cycle according to a user's preferences. By using a piece-wise function to control the heating cycle, greater precision, control, and flexibility in a variety of conditions are achieved compared to existing toasters or other heating appliances. A piece-wise function as used herein is a function composed of two or more sub-functions. Temperature as used herein is one example of a parameter as a target or sensed value. In other embodiments, other parameters, such as physical distance, humidity, visible (or other non-visible spectral) characteristics, derivatives of temperature or other parameters, etc. can be used in place of or in addition to the temperature parameter in order to achieve precision heating of the food item 30. As shown, the selection table 76 has two dimensions, although any number of dimensions, including three or more, can be utilized to provide even greater precision and finer control aspects.

As shown, selection table control process 60 begins at operation 62 when a user depresses a lever (e.g., lever 18) or otherwise initiates a heating cycle. Alternatively, various buttons or electronic controls can be used to initiate the process 60. Prior to operation 62, a user can select a shade (e.g., 1-6, from lightest to darkest setting). For example, shade 1 can be a very light toasting setting and shade 6 can be a dark toasting setting. Following operation 62, a controller (e.g., a microcontroller or controller 162 of FIG. 18) reads a shade value selected by the user and determines a row of the selection table (or “matrix”) 76. The selection table 76 preferably includes columns 78 and rows 80 in two dimensions (X and Y axes) as shown. Following operation 64, the microcontroller operatively reads a starting temperature from a temperature sensor (e.g., sensor 28) at operation 66, upon which the microcontroller determines the column 78 from the selection table 76 that is applicable. In some embodiments a sensor 28 can detect any sequence or selection of any of 1) a surrounding/ambient (heating cavity 23) parameter/temperature only with little or no measurement of food item 30 itself, 2) a food item 30 surface parameter/temperature, and/or 3) any combination of heating cavity parameter/temperature and the food item 30 surface parameter/temperature. In other embodiments, more than one sensor can be utilized to sense heating cavity 23 and food item 30 parameters/temperatures separately.

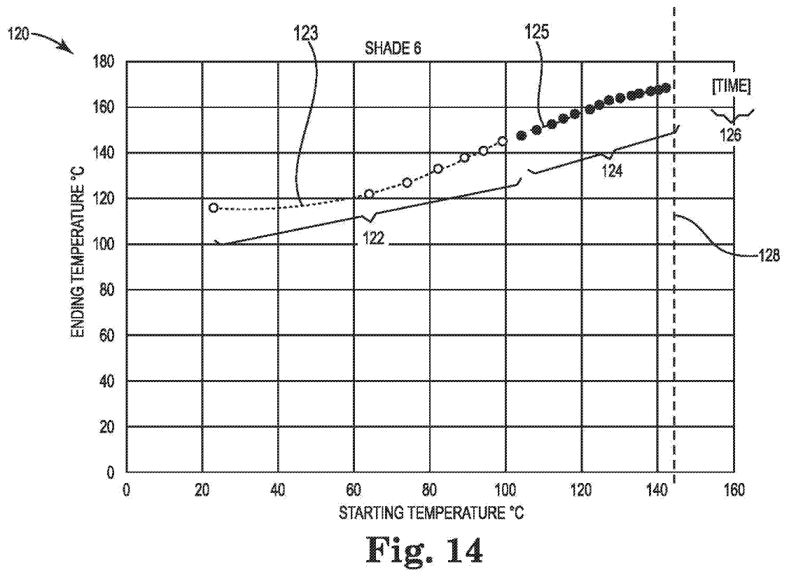

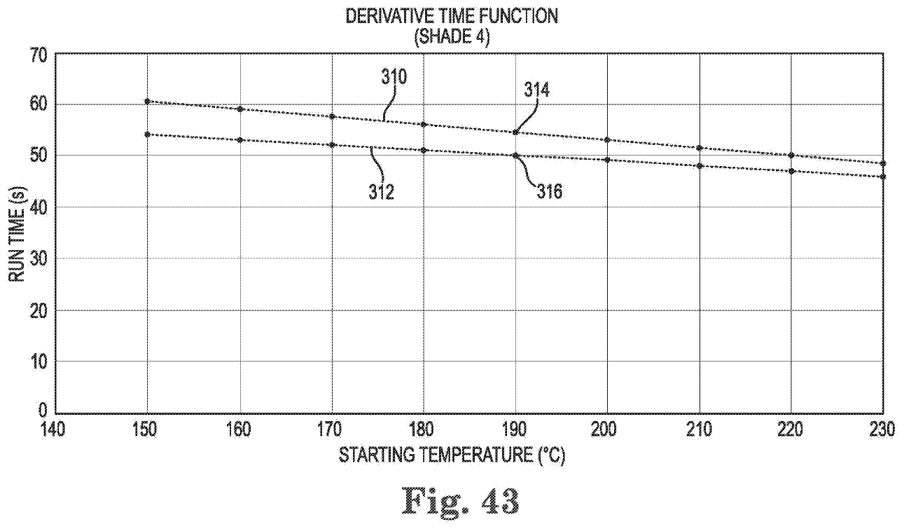

Based on the column 78 of the selection table 76, for example, either an equation-based function can be selected or an only time-based function can be selected at operation 68. Preferably, a first parameter (e.g., temperature) range corresponds to a quadratic equation, a second, higher temperature range corresponds to a linear equation, and a third, yet higher temperature range corresponds to an only time-based function (see FIG. 14). Furthermore, FIGS. 43-45 describe an example further refinement of the hot-start, time-based function of FIG. 14. If the selected column 78 is equation-based (either quadratic or linear), then the process continues to operation 70, otherwise the process proceeds to operation 72. At operation 70, the ending temperature (y) is determined by the microcontroller by plugging in the starting temperature value (x) into the selected equation. Alternatively, and at operation 72, if the controller determines that the starting temperature is greater than a temperature threshold (x_{T}), then the microcontroller uses a time value of N in seconds to determine the end condition and heating time, accordingly. The process 60 then can end at operation 74 once the end temperature or end time condition is met, and the lever (18) can then pop up along with the carriage (44) and food item(s) (30). In other embodiments, the heating process can end with an alarm trigger, and/or without physical movement or a popping of a carriage.

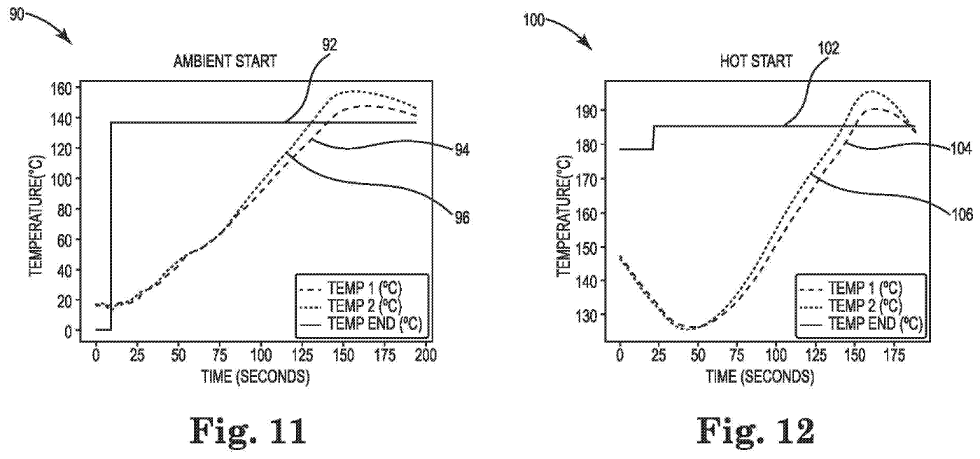

With reference to FIGS. 11 and 12, two contrasting time vs. temperature charts are provided for an ambient (chart 90 of FIG. 11) and hot (chart 100 of FIG. 12) starts of the example heating appliance 10. In general, and as used herein, an “ambient start” refers to a starting condition where components of the heating appliance 10 have substantially reached ambient, room (or in some cases, outdoor) temperature in a substantially uniform manner. In some embodiments, an ambient start can be a start in any of the various starting temperature ranges, such as the quadratic portion of the piece-wise function(s) discussed herein, or in a cooling state but above any thresholds or the like discussed herein. In other embodiments, ambient starts can refer to any resting, steady-state starting conditions. A “hot start” as used herein is a general condition where the heating appliance 10 has recently run a heating cycle and one or more components are heated directly or indirectly and retain at least some heat from the previous heating cycle or a pre-heating cycle. Ambient and hot starts as used herein can equally apply to humidity or any other environmental that may be affected by previously-run cycles and the like. Certain hot starts can reach one or more thresholds and thus place the selected heating parameters in one of the types of selection table piece-wise functions.

As shown, charts 90 and 100 demonstrate various heating curves for heating according to a particular shade level setting for the heating appliance 10. As the lever 18 is depressed, a controller loads and runs control logic to determine an end condition (e.g., temperature). As shown, the “Temp End (° C.)” (92 for FIG. 11, 102 for FIG. 12) lines correspond to logic that is dictated only based on a starting condition (e.g., temperature) as shown at 92 and 102, in FIGS. 11 and 12, respectively. As above, each heating cavity 23 of the heating appliance 10 is provided with a sensor 28. Each sensor 28 can be a NTC sensor (or any other suitable sensor) in various embodiments. As shown in charts 90 and 100, two temperatures “Temp t (° C.)” (94 for FIG. 11, 104 for FIG. 12) and “Temp 2 (° C.)” (96 for FIG. 11, 106 for FIG. 12) correspond to two sensors 28 within the heating appliance 10. The carriage 44 can be biased vertically and selectively held downward with an electromagnet (e.g., as shown schematically in FIG. 18). The carriage 44 can be configured to be released when either temperature sensor reaches the target temperature, e.g., when the lower temperature reaches the threshold of the target temperature. In various embodiments, a four-slice heating appliance can be effectively two, two-slice heating appliances 10 side-by-side with extended slots 20, housing 12 and other corresponding features. Other configurations are also contemplated herein, including any number or size of slots and the like.

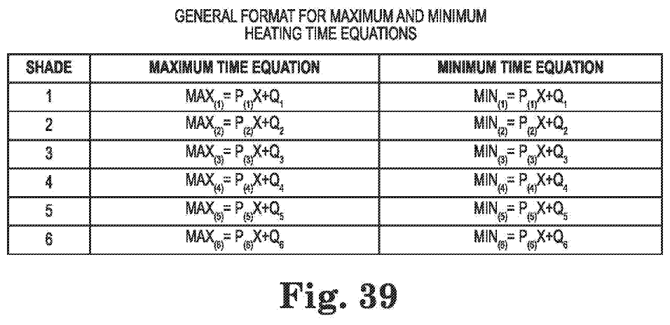

A maximum heating run time for each selected shade setting can be optionally implemented if desired. Based on collected data, the controller can be configured to provide a maximum heating time for each shade of e.g., 125% of a typical heating time for a particular toasting shade level. In addition, the heating appliance 10 can be configured to immediately cease heating operation when a particular maximum temperature threshold is reached, such as 280 or 300° C. In other embodiments, and as described below with reference to FIGS. 39-42, a linear equation can be used for each shade to determine the minimum allowable run time and a linear equation can be used to determine the maximum run time. In various embodiments, the control aspects of the selection-table based control is sufficient to avoid overheat conditions and the like, and maximum and minimum heating times may provide redundant control aspects only.

As shown at chart 90 of FIG. 11, the heating appliance 10 temperature increases relatively linearly over time according to heating card 27 characteristics and a relatively cool (ambient) starting temperature (e.g., about 18-20° C.). In contrast and according to chart 100 of FIG. 12, where the heating appliance 10 has recently completed a heating cycle, a “hot start” condition can be present e.g., when the heating appliance 10 starts about 130-150° C. (or any other temperature greater than about room temperature) and an initial dip can occur (as shown from time 0-50 seconds) while heating elements 31 are in a process of achieving full power load and as a new food item 30 is introduced to the heating cavity 23 prior to starting a second or subsequent heating cycle. The new food item 30 can be frozen or at room temperature, thus providing a “cooling” or sensed cooling at the sensor 28 during an initial period of time. As the equilibrium is met, the sensed temperature starts to rise again. Other parameters can follow any of various patterns during a heating process, and can be determined theoretically or empirically as suitable. As described below with reference to FIGS. 43-45, a derivative (rate of change) of a sensed temperature (or other aspect) vs. time can be further utilized as a parameter for providing precise heating control.

The temperature dip can also be influenced by the thermal inertia stored in the heating appliance and the related cooling of the heating appliance 10. It takes time for the heating cavity 23 to start heating again even once the heating elements turn on. Also as shown, a final time for a heating cycle can be different for a particular shade level setting depending on ambient vs. hot starts for the heating appliance 10. Hot starts can furthermore vary from somewhat hot to very hot starting temperature of various components, and a heating cycle can accommodate a heating cycle time that is dependent on the starting temperature as discussed herein. Typically, and as shown in FIGS. 1I and 12, heating times are preferably shorter when the heating appliance 10 begins as a hot start, and potentially even shorter yet when a rate of change of the heating appliance 10 is positive (heating up), although a final sensed temperature at sensor 28 is preferably also higher than for an ambient start. Where other, non-temperature parameters are used, hot and ambient starts can have any of various heating process properties accordingly.

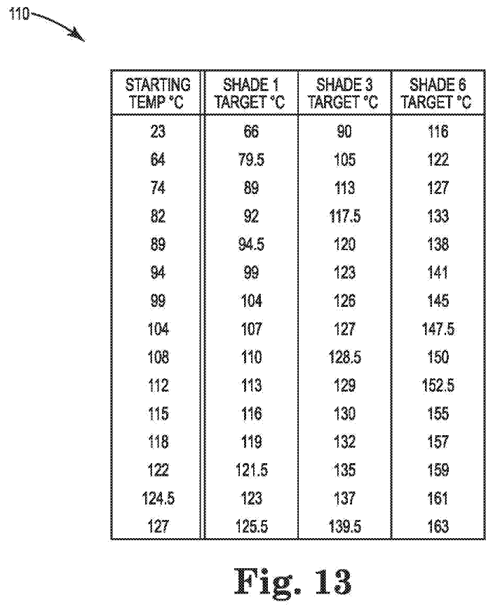

Moreover, FIG. 13 is an example correspondence table 110 of target temperature for a food item (30) after heating using a heating appliance compared to starting temperature. Thus table 110 includes data for both ambient, hot, and other types of starts for heating appliance 10. The data shown in table 110 was produced empirically by testing using a common bread type as a control with a representative heating appliance (e.g., heating appliance 10). Different starting conditions and shades of toast during heating were observed as shown and proper toasting shades were observed to determine the target shade temperatures for each starting temperature. Based on table 110, target temperatures for any possible starting temperature can be interpolated and determined accordingly. Thus, the temperature-based equations (e.g., linear and quadratic) as disclosed herein were derived in part based on empirical data according to a table such as table 110. Other data was also used in the derivation. Table 110 does, however, illustrate a trend of the target end temperatures between different shade values and different starting conditions.

As shown, a target temperature for a food item 30 can increase based on an increase in starting temperature. Also as shown, a darker, higher numerical value as used herein, shade setting preferably corresponds to a higher target temperature. For example, a shade setting of 6 would mean a darker toasting result than a shade setting of 4.

FIG. 14 illustrates an example of process 60 of FIG. 10 as a graph 120 showing a relation of starting temperature to desired final temperature according to an example piece-wise function having three portions. Graph 120 illustrates a correspondence between a starting temperature and a desired ending temperature for a selected toasting shade level (here, shade 6), according to various embodiments. A regression of test data (e.g., of FIG. 13) can be used to produce the data shown at graph 120. Shown is an example for a shade setting of 6 (e.g. maximum, darkest setting). Graph 120 includes a quadratic portion 122 (with corresponding resulting quadratic polynomial line 123) that models data for a heating process starting (here, from a roughly 120° C. “hot” start), after which the piece-wise function transitions to a linear portion 124 (with corresponding resulting straight line 125) up to a threshold temperature (x_{T}) 128.

The threshold temperature (x_{T}) 128 can be selected to be a value beyond which greater inconsistency in the toasting shade is likely to happen, sometimes referred to as a “hot-hot” start. If the threshold temperature (x_{T}) 128 (e.g., 142° C., 150° C., etc.) is determined as a starting temperature, then a time-only portion 126 of the piece-wise function at 120 is initiated and only time is used to determine when the heating cycle will end for a properly heated food item 30. The ending temperature shown on the Y-axis is preferably calculated once based on the starting temperature shown on the X-axis. Therefore, preferably only a single target ending temperature (or time-based countdown) is produced based on the starting temperature reading from sensor 28. Additional piece-wise function models and/or portions could be added in other optional embodiments, including for other types of heating appliances and the like. With reference to FIGS. 43-45, below, the tire-based only heating portion of the piece-wise function can be further refined based on a time derivative of one or more sensed aspects at a point in time, such as a sensed temperature at sensor 28 at the present time or other point in time.

Still with reference to FIG. 14, the quadratic portion 122 can benefit from quadratic modeling due to the housing 12 of the heating appliance (e.g., heating appliance 10) absorbing much of the heat at outset of heating cycle operation and causing a non-linear correspondence over time. The stabilized, linear portion 124 corresponds to a steady increase in temperature within the housing 12 during operation. For example, once the heating appliance 10 has become fully heat soaked and is in a relatively steady state thermally. Each equation coefficient is preferably determined for each shade setting. Transition temperatures from the quadratic portion 122 to the linear portion 124 are preferably seamless and yield a substantially same ending temperature at one or more transition.

In various embodiments, the quadratic equation of the quadratic portion 122, the linear equation of the linear portion 124, and the time-based equation of the time-based portion 126 each correspond to a non-overlapping range of starting temperatures. In various embodiments, the quadratic equation of the quadratic portion 122 is used to calculate an ending temperature based on the starting temperature and the toasting shade level selection. In various embodiments, the linear equation of the linear portion 124 is used to calculate an ending temperature based on the starting temperature and the toasting shade level selection. In various embodiments, the time-based equation of the timed-based portion 126 is used by the controller to calculate an ending time based on the starting temperature and the toasting shade level selection. In various embodiments, the starting temperature is a starting internal temperature of the heating appliance 10. The starting internal temperature of the heating appliance 10 can be ambient, partially heated, and variations thereof. In yet further embodiments, any number of portions of the piece-wise function can be implemented, including one or more of any of the above-described portions, and more or fewer than three portions can be utilized accordingly.

Although not shown, additional or alternative portions can be included in anv embodiments herein, Including cubic (third exponential power) and/or higher power equations. Derivative (e.g., time-derivative) refinements of one or more of the portions can also be used to select one or more sub-equations, e.g., using a three-dimensional selection table (see FIGS. 43-45).

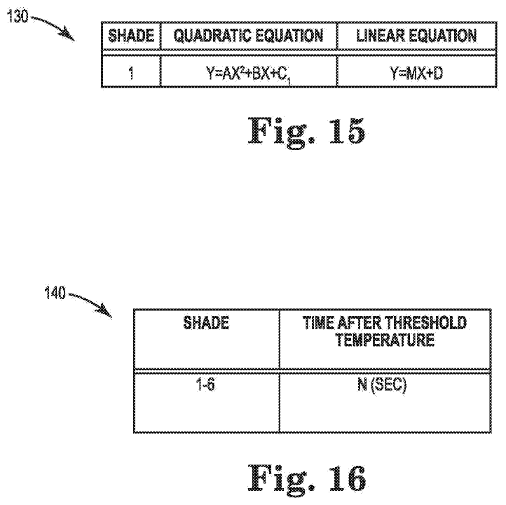

FIG. 15 is a chart 130 showing example quadratic and linear equations for a given toasting shade level (shade level 1 as shown), according to various embodiments. As shown, an example quadratic equation is y=Ax²+Bx+C with y representing the target temperature, and x representing the starting temperature. Constants A, B, and C can be selected enpirically or through simulations or otherwise. The example linear equation is y=Mx+D if the linear portion of the piece-wise function is selected as shown at FIG. 14. Constants M and D can be selected similar to constants A, B, and C of the quadratic equation. Optionally various constants can be appended herein with a number (e.g., D6) to denote a constant that optionally corresponds to a desired toast shade level or the like,

FIG. 16 is a chart 140 showing an example time-based equation for various toasting shade levels, according to various embodiments. Each shade level can have a unique or respective amount of time for countdown upon initiation depending on the selected shade level (e.g., 1-6). Therefore, a time for countdown at shade level 6 (darkest setting) would preferably be longer than for shade level 1 (lightest shade level setting). In particular, it was determined that a darker toast shade level setting paired with a relatively hot starting temperature led to suboptimal toasting results. Inconsistencies were observed in toast shade at high starting temperatures in part because of housing 12 rapidly cooling. One or more derivatives (e.g., of temperature vs. time, see FIGS. 43-45) can be calculated and used, for example with the time-based heating, in order to further refine performance and lead to more precise, consistent results.

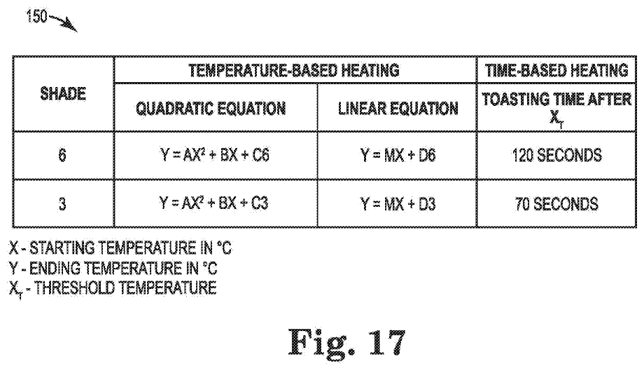

FIG. 17 is an example two-dimensional, partial matrix (or “selection table”) 150 for selected toasting shade levels, according to various embodiments. The matrix 150 can incorporate details from FIGS. 15 and 16 into a single matrix, including example constants and identified countdown values. In the example as shown, the quadratic equation constants A and B are the same for shades 6 and 3, but the C constant is changed. Likewise, for the linear equation, the M constant as shown in the same for shades 6 and 3, but the D constant is changed in the example as shown. When reached, the threshold temperature (x_{T}) can start a countdown of a predetermined time, such as 120 seconds for maximum shade setting 6 and 70 seconds for shade setting 3. Therefore, in various embodiments, the countdown predetermined time is preferably higher for darker shades and lower for lighter shades in general. As discussed herein, a derivative of temperature vs. time can be used to further refine the count-down timer as applicable.

In yet further embodiments, a second, higher threshold temperature parameter can be utilized, above which the heating appliance 10 runs for an even shorter but still time-based countdown, or is programmed to not run a heating cycle at all until the heating appliance 10 has cooled to a certain temperature level, e.g., the x_{T} or some variation of x_{T}+n (degrees), or the like. Therefore, in some examples, a four-part piece-wise function can be utilized, such as one including two separate time-only based portions, each of which can be optionally bolstered using various derivative-based adjustments for greater precision.

FIG. 18 is a schematic diagram of an example heating appliance, e.g., heating appliance 10, according to various embodiments. As shown, the heating appliance 10 includes the heating card 27 operatively connected to at least a power circuit 166 and a controller 162. The controller 162 is also operatively connected to the sensor 28. In preferable embodiments at least one of the controller 162, the power circuit 166, and the heating card 27 is also operatively connected to an electromagnet 164 configured to hold the carriage 44 down when the lever 18 is lowered as described herein. The controller 162 preferably includes at least a hardware processor and a memory and can be embodied in an application-specific integrated circuit (ASIC) in various embodiments. The heating card 27 preferably includes one or more heating elements 31 as shown. Applicant also hereby incorporates by reference U.S. Pat. No. 10,813,496 entitled “SECONDARY CIRCUIT AND TIMING DEVICE FOR APPLIANCE” in its entirety and for all purposes herein. Additional power circuit aspects of the above reference are understood to be applicable to the present disclosure where appropriate. The controller 162 can optionally sense and control heating card 27 power consumption and resulting temperatures, and can in some embodiments vary heating card 27 heat rate and power usage over time in order to adjust a rate at which a food item 30 is heated, such as according to sensed parameters and/or derivatives thereof. For example, a higher starting temperature can use a first heat cycle and a lower starting temperature can use a second heat cycle adjusted to a set of starting conditions, including optionally derivatives (e.g., time derivatives) of starting condition data such as sensed temperature, etc.

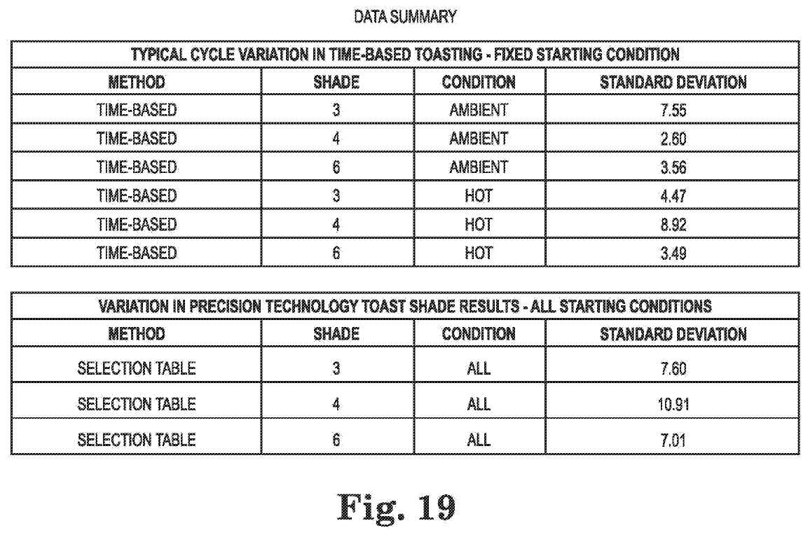

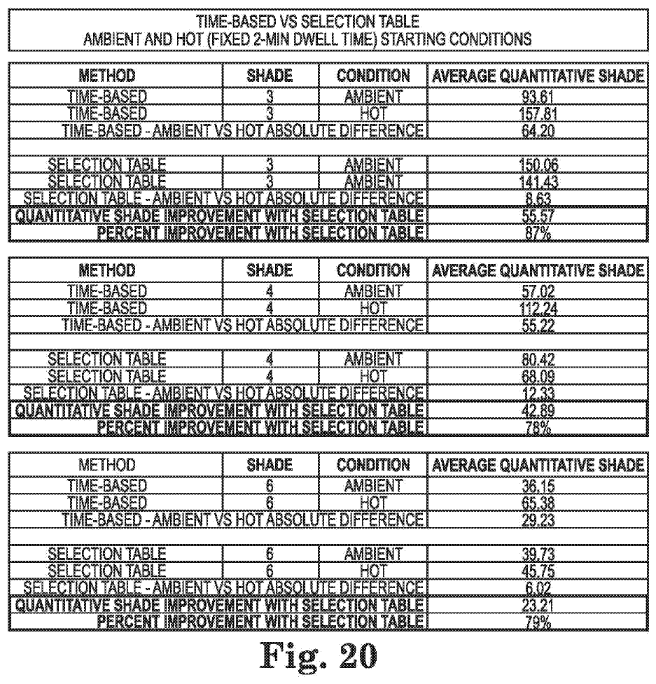

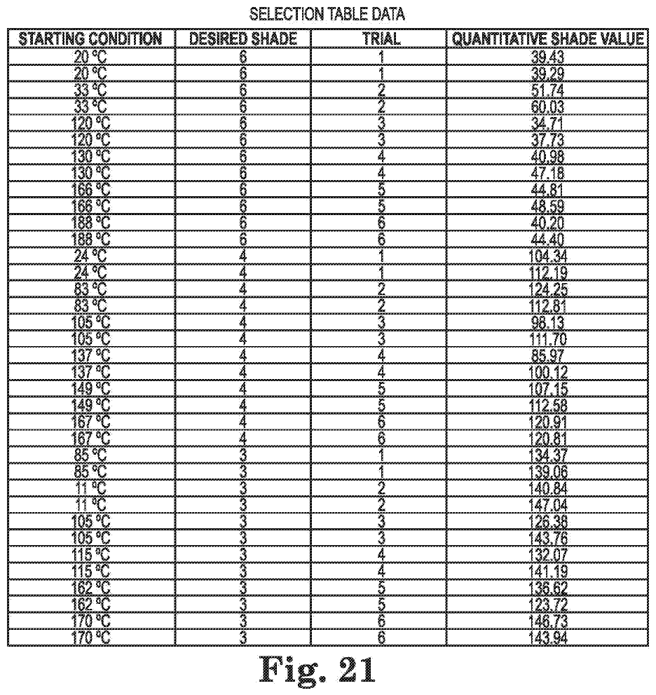

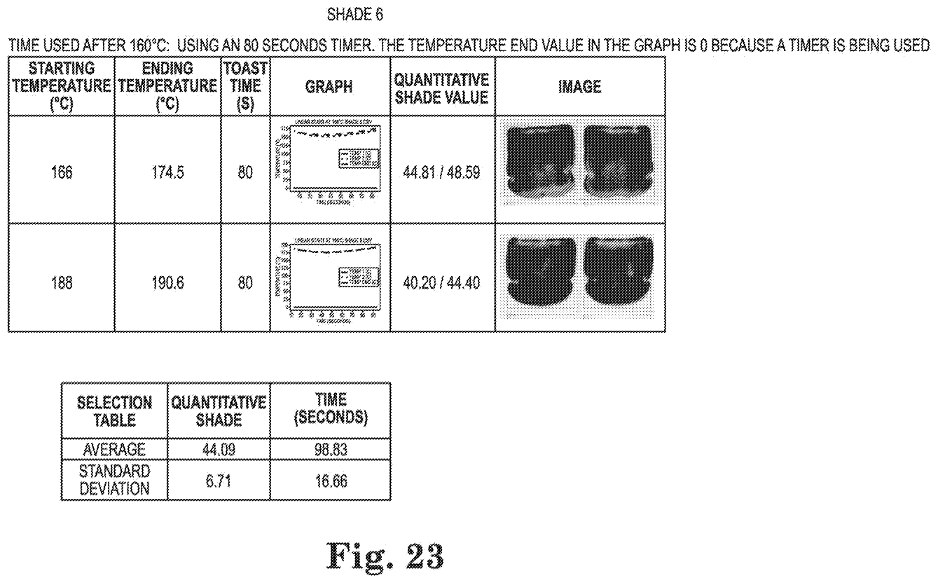

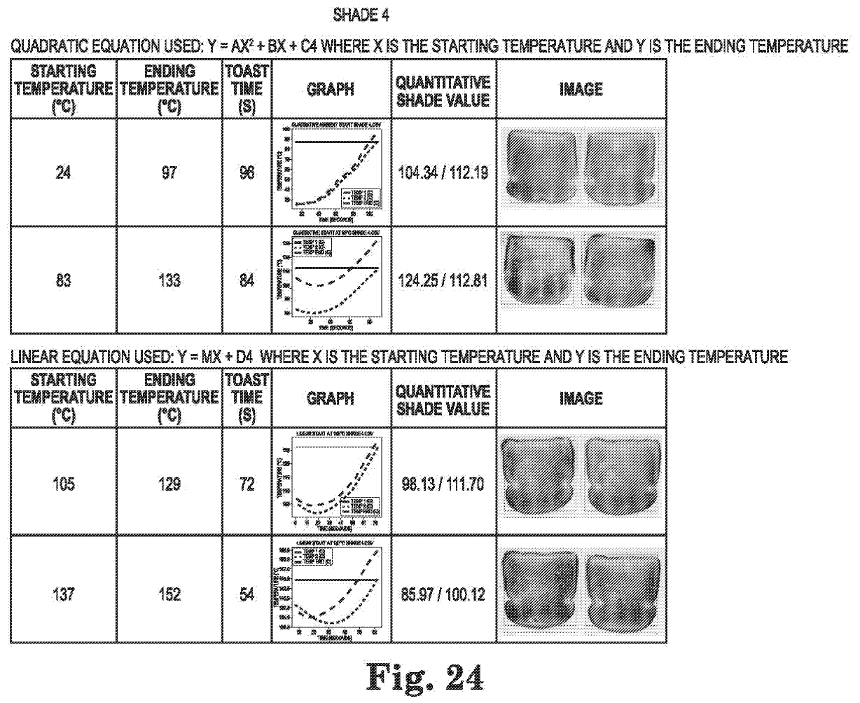

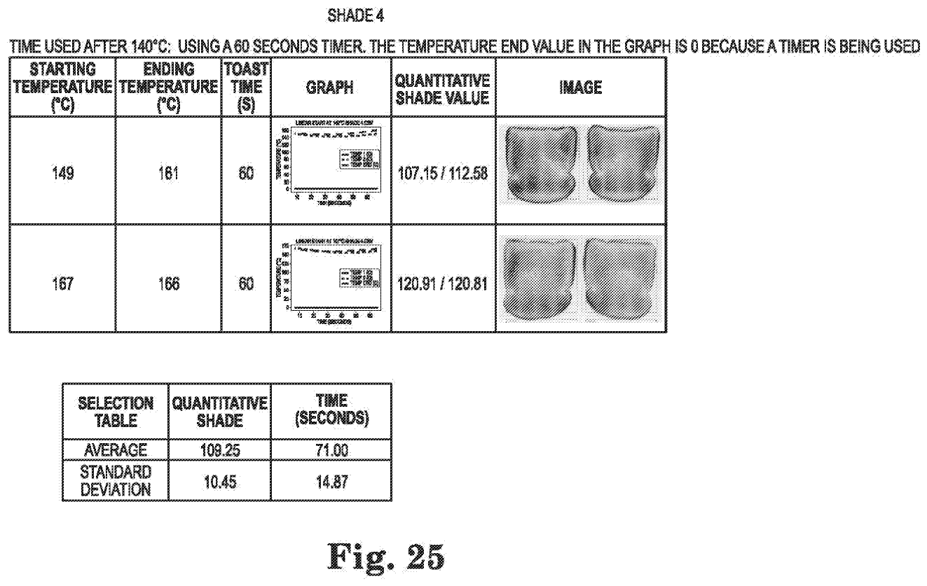

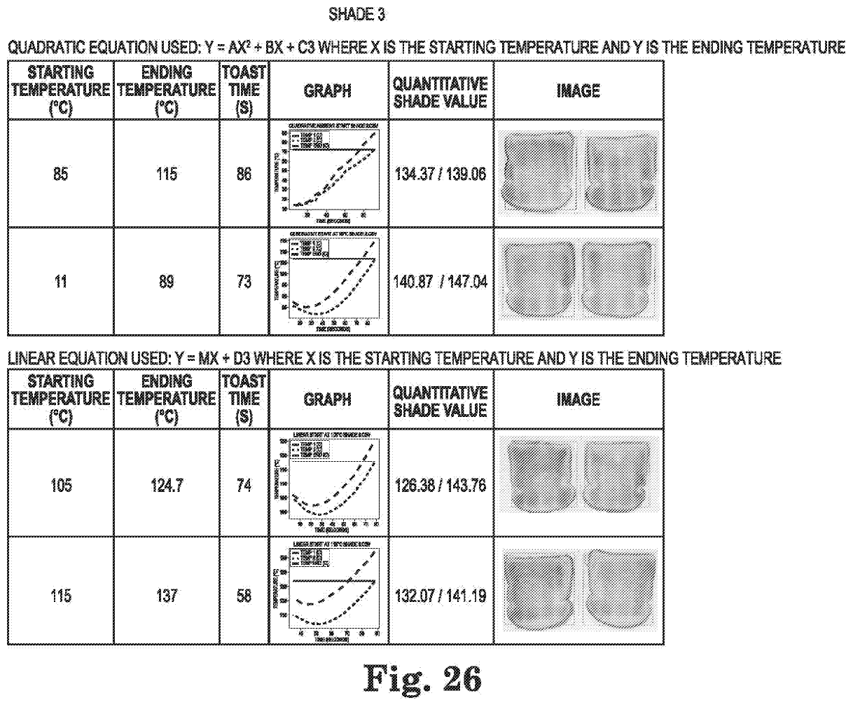

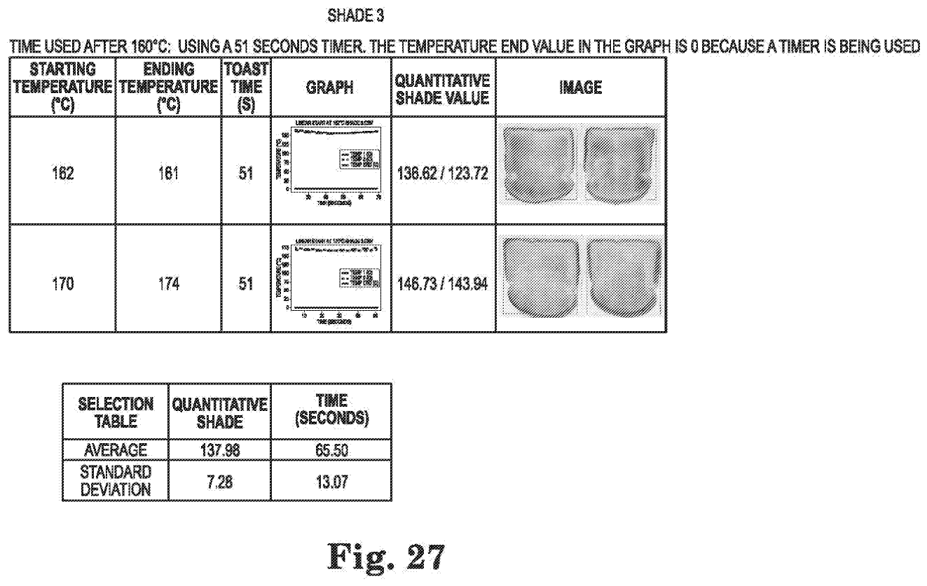

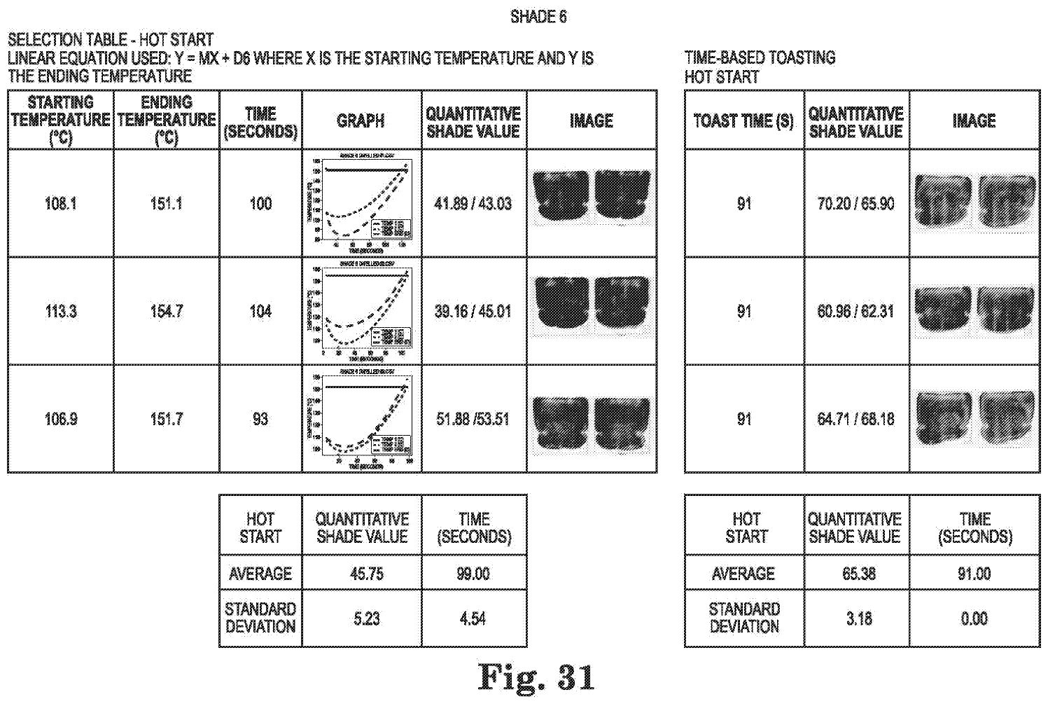

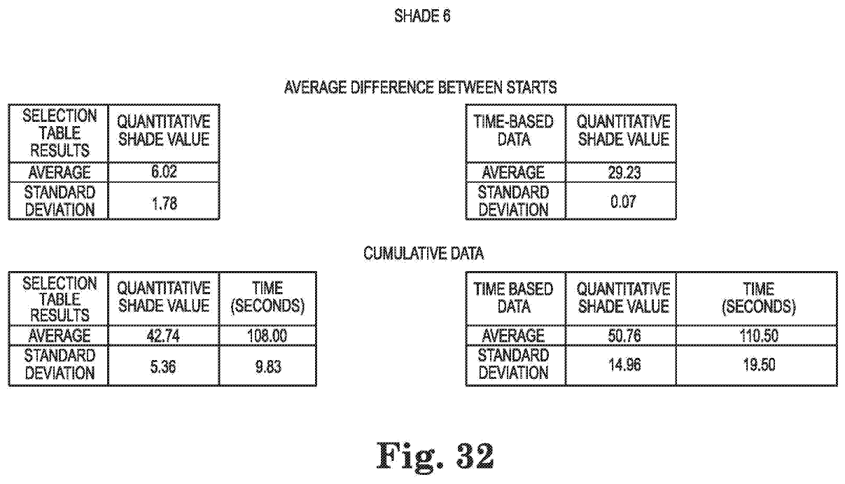

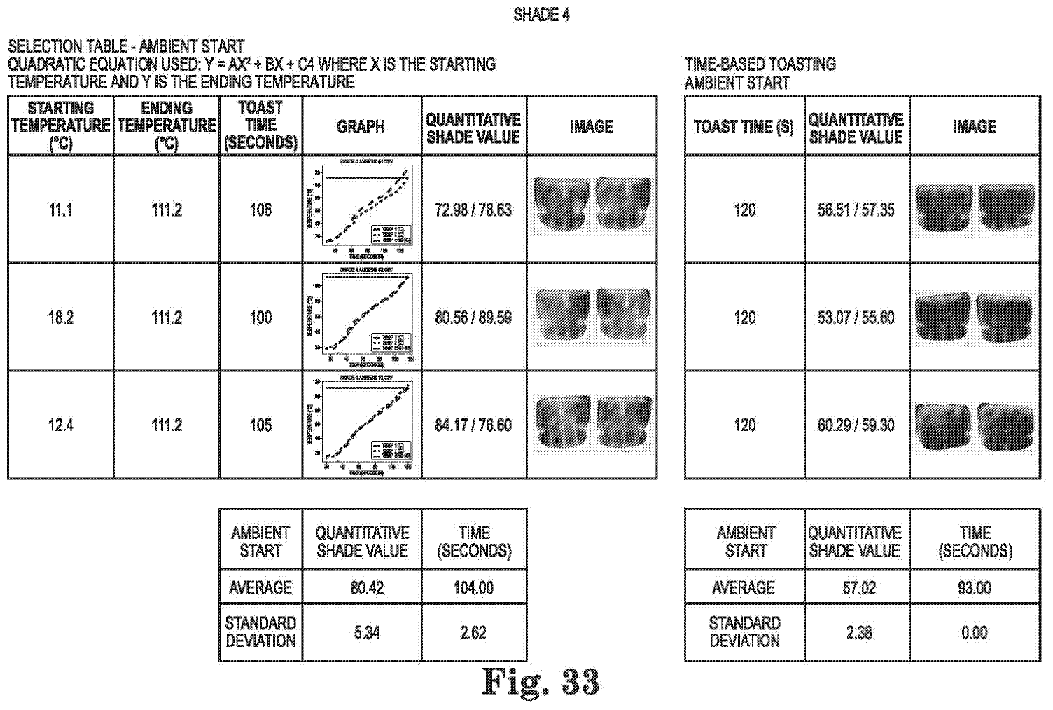

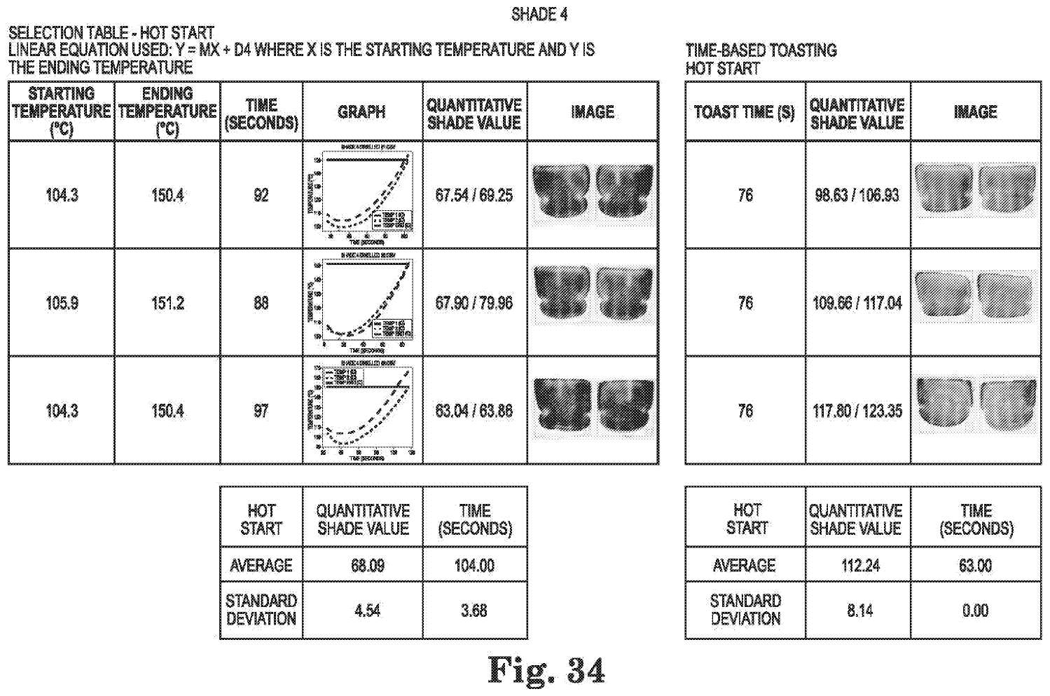

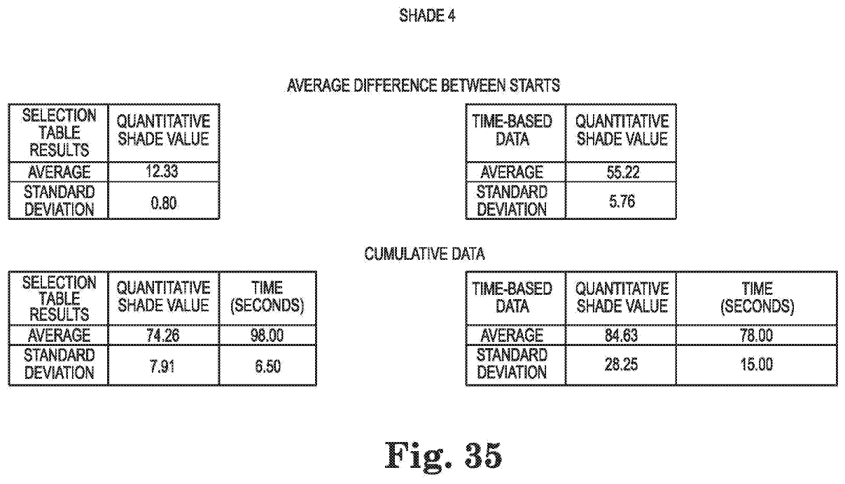

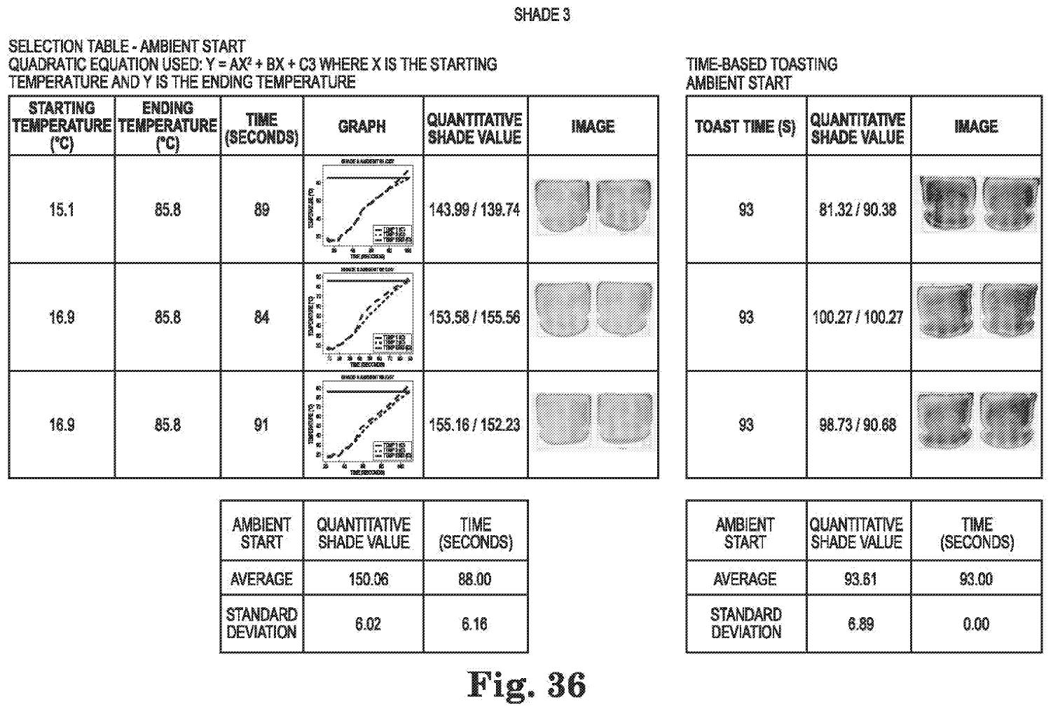

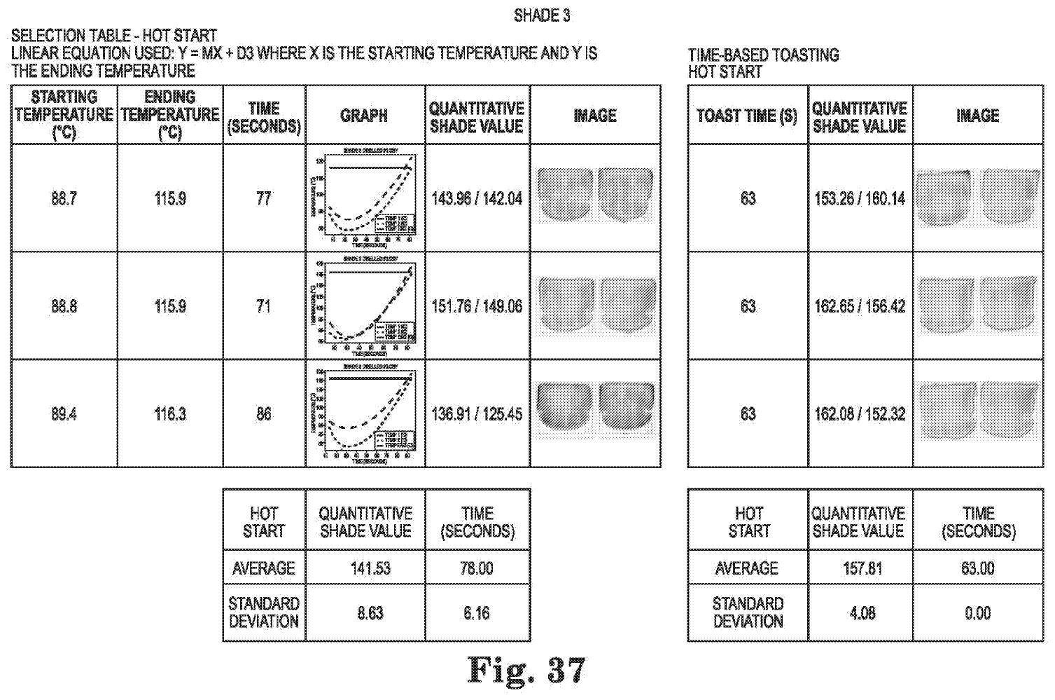

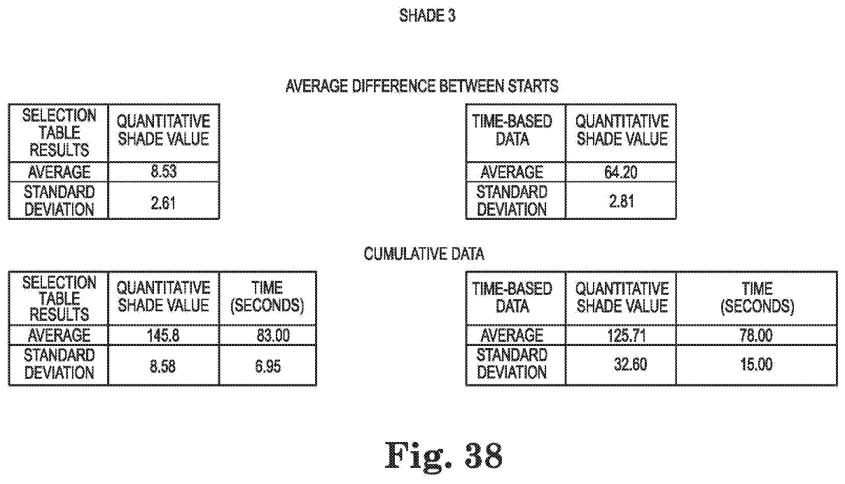

With reference now to FIGS. 19-38, test result data for the disclosed piece-wise, selection table-based control for a heating appliance 10 is presented, and more specifically for a pop-up type toaster. Comparative test data for existing timed toasters (an example of a heating appliance) is also shown. As shown, the test data for disclosed selection table control embodiments provides quantifiable benefits in precision and consistency as compared to the conventional, existing time-based heating cycle and control. Both numerical and visual data are presented as further evidence of the benefits of the present disclosure.

FIG. 19 shows a summary of cycle variation data for a time-based heating with a fixed starting condition compared to a disclosed selection table method with all starting conditions, according to various embodiments. For existing “time-based” only control for existing toasters, each of “hot” and “ambient” starts as described herein at shown with standard deviations for shade levels of 3, 4, and 6. For “selection table” methods according to piece-wise functions for improved control as described herein, various conditions (e.g., starting/ambient temperatures) are combined in a summary with associated standard deviation. See also FIGS. 20, 21, 28, and 29.

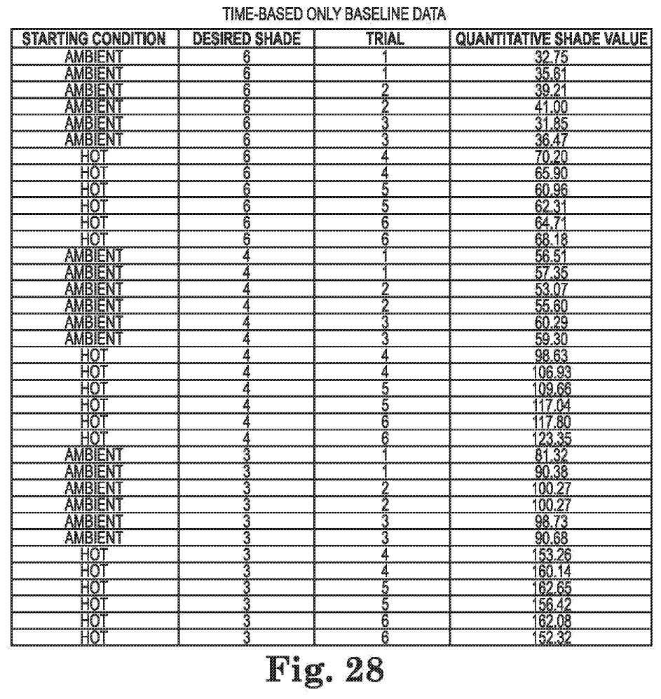

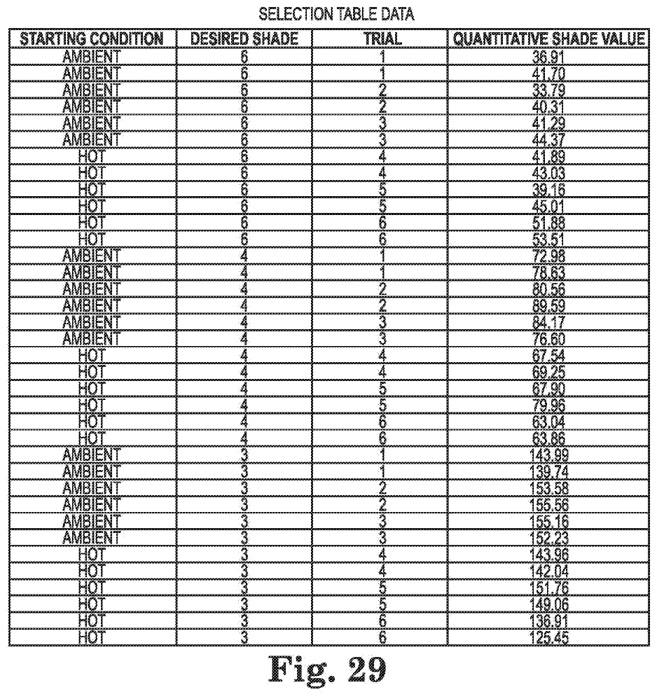

FIG. 20 shows additional summary data of cycle variation data for a time-based heating with a fixed starting condition compared to a disclosed selection table method with all starting conditions, according to various embodiments. The comparison in FIG. 20 offers a more direct comparison of the time-based existing methodology to the improved selection table methodology described herein. As shown, at various shade settings, the selection table-based techniques according to various embodiments herein was shown to have a more consistent and even toasting shade of between 78% and 87% improvement over the time-based baseline when comparing ambient and hot starts. So also FIGS. 28 and 29.

FIG. 21 is a data table with quantitative shade values for disclosed selection table techniques for various shade levels, according to various embodiments. Quantitative shade values for assessment and comparison can be determined in various ways, including by any manner disclosed in U.S. Pat. No. 10,819,905 and/or U.S. Pat. App. Pub. US2021/0015300A1, which are both hereby incorporated by reference for all purposes herein. The quantitative shade values allow for direct comparison and provide evidence that the disclosed precision, selection table control embodiments achieve more accurate toast shade results.

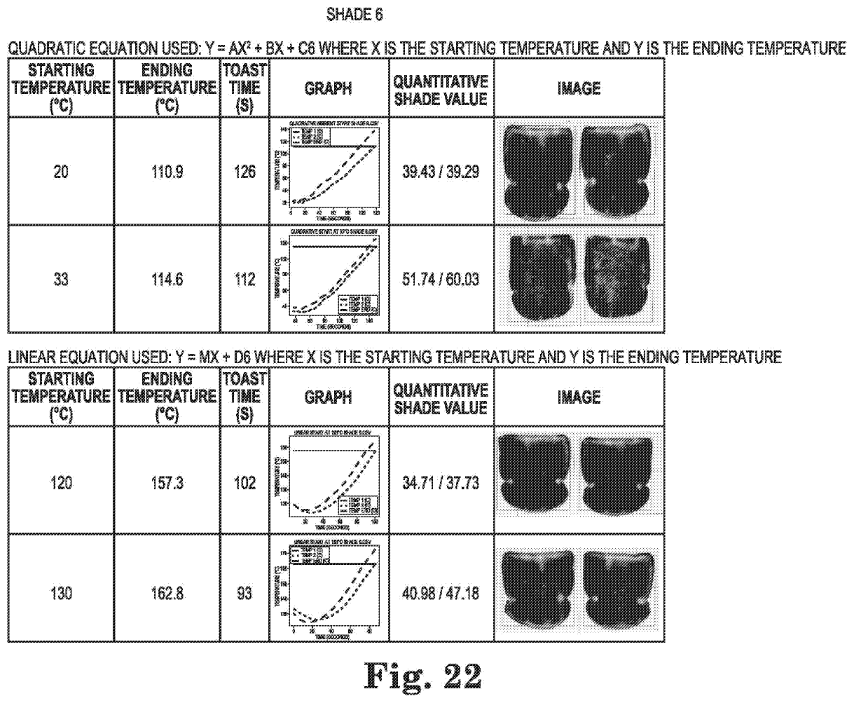

FIGS. 22-27 show data for disclosed selection table-based embodiments as compared to existing time-based only heating methods for certain shade settings. Shown are graphical representations of the heating process, the starting temperature, the toast time (heating time), the quantitative shade values, and an example image from testing.

The example procedure used in testing included a number of steps. A toaster (e.g., heating appliance 10) including a controller (e.g., 162) programmed with the precise “selection table” piece-wise heating function (described above, e.g., see FIG. 10) was utilized. First, two slices of white (e.g., “Bimbo” brand) bread were inserted into the toaster and the desired shade was selected. Second, the toaster was configured to record the starting temperature and to calculate the target end temperature as described herein. Third, the two slices of bread were heated until the cycle completed when the toaster was determined by the sensor (e.g., 28) and controller (e.g., 162) to have reached the calculated target end temperature. Finally, the subject toaster was re-tested at a variety of starting temperature conditions and toasting shades.

FIG. 28 shows baseline testing data for existing time-based control. As shown, hot and ambient starting conditions were tested using an existing toaster in multiple trials each for shade levels 3, 4, and 6. A quantitative shade value result was determined as described above.

FIG. 29 shows testing data for disclosed selection table-based control using a piece-wise function, according to various embodiments. As shown, hot and ambient starting conditions were tested using the improved “selection table” toaster in multiple trials each for shade levels 3, 4, and 6. A quantitative shade value result was recorded. The data of FIG. 29 is therefore directly comparable to the existing toaster data of FIG. 28. FIG. 20 provides a summary of the data of FIGS. 28 and 29.

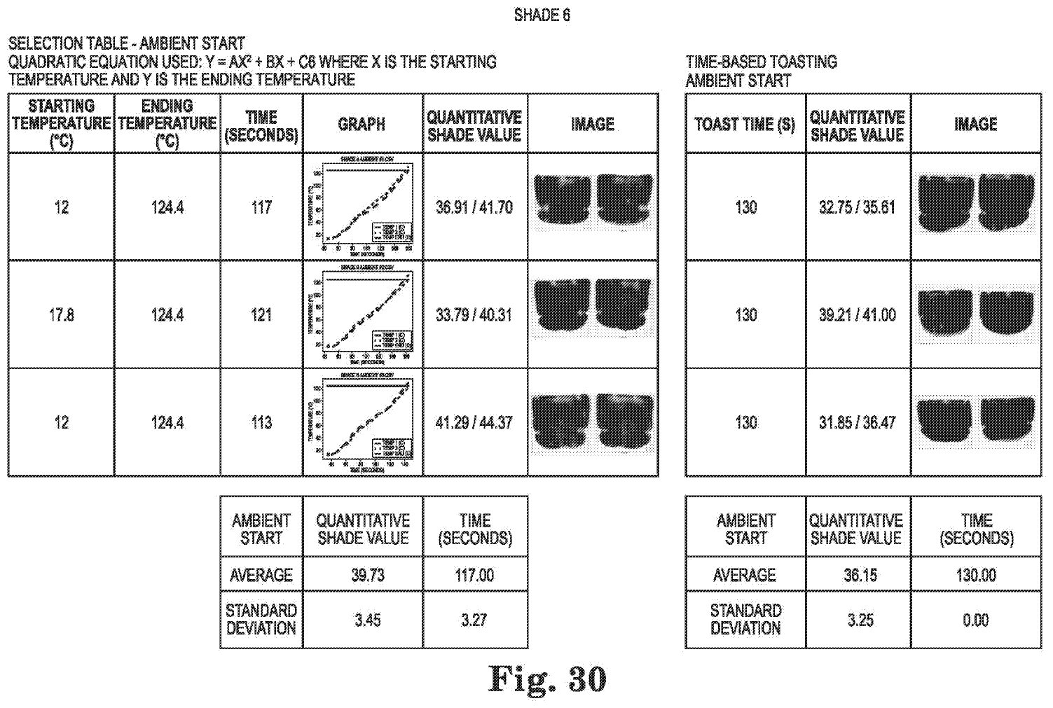

FIGS. 30-38 show data for ambient and hot starts, including visual results for various shade settings. Also shown are comparisons of existing time-based methods as compared to disclosed selection table control methods for various shade settings, according to various embodiments. Shown are graphical representations of the heating process, the starting temperature, the toast time (heating time), the quantitative shade values, and an example image from testing. Also provided is a data average and standard deviation from testing data. Shade values as shown in the data table were determined as described above.

The test procedure used to attain the data for FIGS. 30-38 included various steps and utilized an example toaster (e.g., a two-slice pop-up toaster), starting at room temperature (i.e., ambient starting parameter condition). A desired shade was selected and two slices of white (e.g., Bimbo brand) bread were inserted into the toaster and heated according to the desired shade setting. After the heating cycle completed and the toast popped, the toaster was allowed to naturally cool for two minutes. Another heating cycle was then initiated, in which two additional slices of white (e.g., Bimbo brand) bread were toasted. This is referred to as the hot starting condition. Then the example toaster was cooled with a fan for ten minutes before another toasting test cycle was performed by repeating the previous steps for different shade settings, etc.

With reference now to FIG. 39-42, an alternative set of embodiments that incorporate the characteristics of the precision, selection table-based, control of e.g., FIG. 10 above, but further incorporate both minimum, and maximum heating time bounds, is presented. In addition to the piece-wise temperature functions for each shade setting as described above, either or both of two additional equations can be implemented to govern the minimum and maximum time bounds of heating. These time bounds can be calculated using a linear equation based on desired shade and starting temperature parameter. These maximum and minimum time equations create an additional layer of control to the target end temperature-based heating to ensure acceptable toast results in extraordinary circumstances.

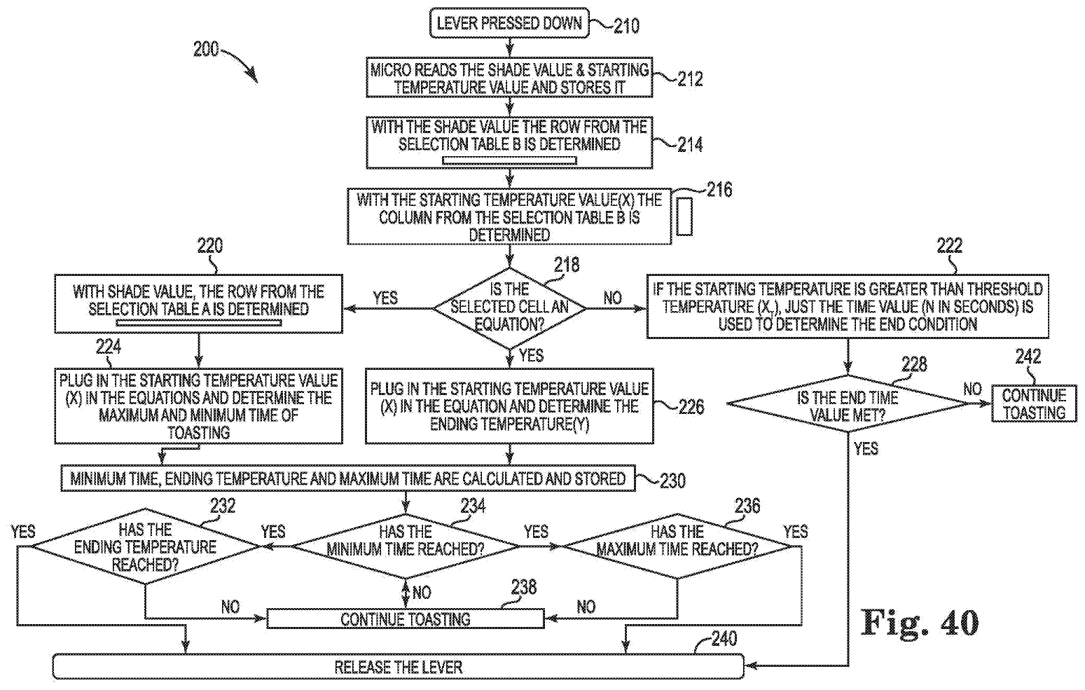

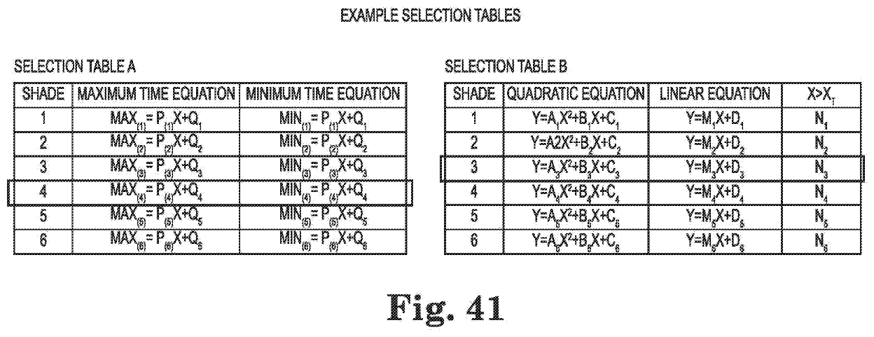

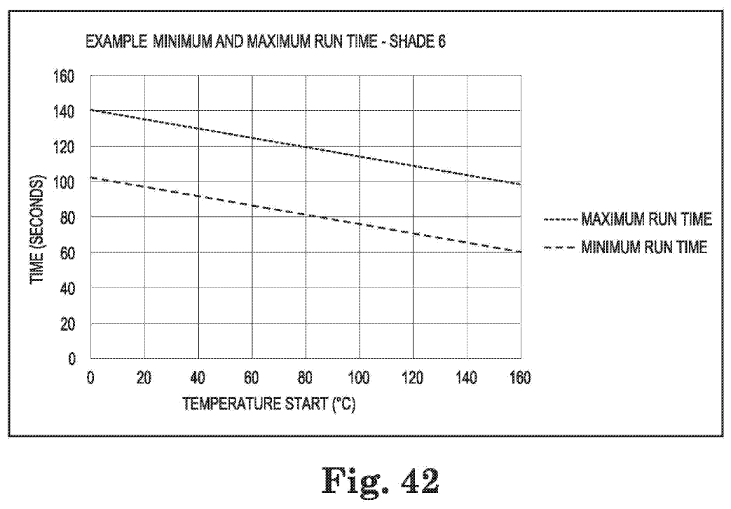

FIGS. 40 and 41 show a flowchart for an example control process 200 and logic embodiment and associated selection table (matrix). FIG. 39 shows a general format of heating time equations for use therewith. FIG. 42 shows graphically and numerically how example minimum and maximum heating times correlate to starting temperature and heating time in seconds.

In such example minimum and maximum time bound equations, the general linear format of y=Mx+B can be used, where the “x” is starting temperature and “y” is time. There can be separate minimum and maximum time linear equations for each shade. This provides a more comprehensive way to bound the heating performance by time. This includes time-based aspects, but builds on the precision control selection table, piece-wise formulas described herein to provide more effective and consistent toast shade versus using a fixed amount of time. In some embodiments, the equations for the minimum and maximum time bounds have substantially similar slopes, but different y-intercept values.

By optionally having maximum or limits to run time for the heating cycle based on the starting condition, predictable and desirable operation parameters of the toaster are maintained while still producing a desired toast shade result. In addition, in special scenarios where the sensor 28 does not sense the target end temperature (or other parameter as applicable) in an appropriate amount of time, the maximum run time can prevent the food item from being over-toasted.

In other special or unusual circumstances or conditions, the temperature sensor 28 reading could rise quickly and meet the target end temperature condition before the food item 30 is done heating. By providing minimum heating time for each shade based on starting temperature, the bread is ensured to stay heating inside the cavity 23 for enough time on all operating conditions to get closer to the desired and selected shade setting.

During operation, the toaster (e.g., heating appliance 10) would run for the minimum time after which the control logic in process 200 of the flowchart of FIG. 40 can be used to determine whether the end temperature condition has been reached according to selection tables (see FIG. 41). If yes, the toaster would end the heating cycle immediately. If no, the heating cycle will continue until the end temperature condition or maximum time condition is met.

For each shade setting, if the starting temperature of the sensor 28 within the heating cavity 23 exceeds the threshold temperature (x_{T}), the timer portion of the piece-wise function would take precedence in controlling the logic. Therefore, the embodiments described with reference to FIGS. 39-42 provide yet additional and optional benefits when implemented with the precision selection table-based control as described herein.

More specifically, and with reference in particular now to the flowchart of FIG. 40, a process 200 can be begin at operation 210 when a lever is pressed down preferably after a food item is inserted into a heating appliance such as a toaster. Optionally, operation 210 can include a selection of one or more buttons, knobs, or any other act that initiates a heating process without a lever. The process 200 then continues to operation 212, where a hardware microprocessor operatively connected to at least a memory receives and reads a shade value and a starting temperature and stores both shade and starting temperature values. Next, at operation 214, based on the stored shade value, the microprocessor determines the row from the selection table (B) (see FIG. 41). Next, at operation 216, with the starting temperature value (X), the microprocessor determines the corresponding column from the selection table (B). Further selections, such as receiving a derivative value and using a third selection table dimension for derivative values are optionally contemplated.

Next, according to process 200, at operation 218, the microprocessor determines if the selected cell of the selection table contains an equation. If yes, the process 200 proceeds to operation 220, and if no, the process 200 preferably proceeds to both operations 222 and 226.

At operation 220, with the shade value, the microprocessor determines the row from the selection table (A). At operation 224, following operation 220, the starting temperature value (X) is plugged into the equations and the microprocessor optionally determines the maximum and minimum times for toasting. At operation 226, the starting temperature value (X) is plugged into the equation by the microprocessor to determine the ending temperature (Y). Following operations 224 and 226, the process 200 proceeds to operation 230. At operation 230, the microprocessor calculates and the associated memory stores, the ending temperature, and optionally the minimum time and the maximum time.

Next, at operation 234, the microprocessor optionally determines if the minimum time has been reached. If yes, the process 200 proceeds to both operations 232 and 236, if no, the process proceeds to operation 238. At operation 232, the microprocessor determines if the ending temperature has been reached. If yes, the lever is caused to be released at operation 240. If no, toasting continues at operation 238. At operation 236 the microprocessor optionally determines if the maximum time has been reached. If yes, the lever is caused to be released at operation 240. If no, the toasting continues at operation 238. At operation 234, if the microprocessor optionally determines that the minimum time has not been reached, then the process 200 continues to operation 238 and the toasting continues.

At operation 222, the microprocessor determines if the starting temperature is greater than threshold temperature (x_{T}), and if so, just the time value (N in seconds) is used to determine the end condition for toasting. Following operation 222, it is determined whether the end time value is met; if yes, the lever is released at operation 240; if not, toasting continues at operation 242. Operation 228 can optionally follow operation 242 in a loop until the end time value is met at operation 228. When the lever is released (e.g., by deenergizing an electromagnet or the like) at operation 240, the process 200 can end.

Various embodiments described herein refer to selection tables or matrices that include two dimensions (X and Y-axes) for selection of various portions of a piece-wise function for performing a heating process. In various other examples, the tables or matrices can be in three dimensions (or more, e.g., X, Y, and Z axes) and can utilize more than one parameter type to select a portion of a piece-wise function. For another example, a piece-wise function can be used to select an equation from a selection table based on both sensed temperatures and humidity levels in order to determine a heating cycle target temperature and/or any other measurement (or derivative thereof) of doneness such as color, or alternatively to determine a target heating time based on the multiple types of sensed parameters,

FIG. 43 shows a further variation and optional embodiment in which a correspondence for an example time-only based portion of a selection-table method is further configured to utilize time-derivative information to refine the time-only based part of the selection table methods described herein, Shown is a correspondence between run time and starting temperature for a hot start as further utilizing a derivative time function based on a sensed temperature at example shade level 4.

Another factor or dimension can be used to y et further refine the selection-table and piece-wise functions described above. For example, a derivative function (e.g., of sensed or otherwise determined temperature or other parameter at a point in time) can be used to more precisely set a time limit in the time-based only portion of the selection table for a heating appliance. In some embodiments, the example time-derivative-based function for selecting a more precise equation is only used on hot-hot starts, e.g., heating appliance 10 starts above threshold temperature (x-r) or higher (e.g., above x-r, approximately 142-150° C.). In other embodiments, time-derivative-based functions can be used at any temperature range, including for quadratic and linear equation portions of a piece-wise function as described herein. In one example, a refined derivative-based method works by determining a lowest value of one or more sensor 28 and then determining whether the slope at a selected point in time (e.g., the present) is increasing or decreasing. This is done by looking at the sign of the slope at that point in time, i.e., (+) for upsloping or (−) for downsloping.

In the specific example for time-based heating, if the slope is positive at the cycle start, a “heating up hot-hot start” function 310 can be used (composed of data points 314). If the slope is negative at the cycle start, a “cooling down hot-hot start” function 312 (composed of data points 316) can be used. As shown, both functions 310 and 312 are linear, with the function 310 generally having a higher corresponding run time and a somewhat more downsloping shape. Based on the above and on the determined starting temperature, a more precise run time can then be selected based on the starting conditions, including the time-derivative of the sensed temperature. This derivative data and further selection table refinement then enables both hotter starts (hot-hot start functions) to deliver an accurate toast shade level regardless of whether the toaster has been used recently (with a potential for a potentially lagging thermal inertia influence), let to cool down slightly in the starting temperature range above the threshold temperature (x_{T}). Thus, utilizing time-derivative data can optionally provide even greater precision in a wider range of conditions and the like, particularly for time-based heating according to embodiments herein.

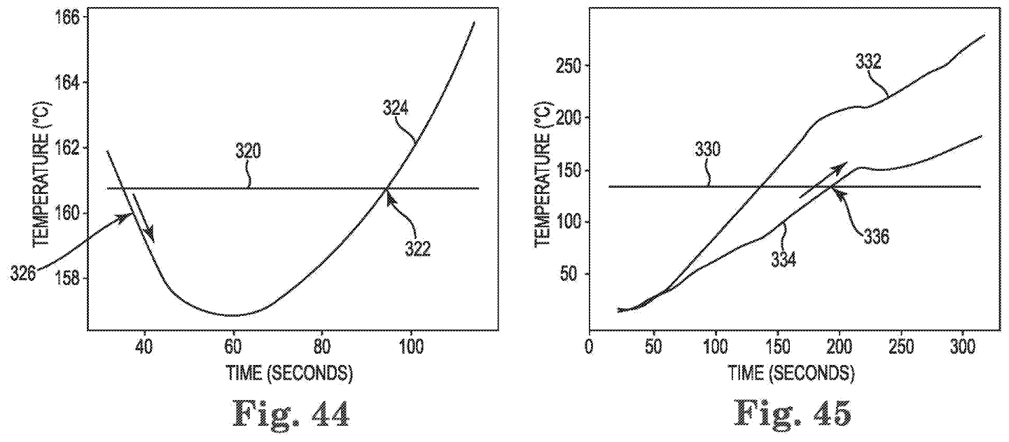

FIG. 44 is an example of a temperature vs. time function where a heating appliance is cooling as determined at a sensor. As shown, a temperature vs. time curve 324 is read at a point in time as shown at 326. The time associated with point 326 can be when a user starts a heating cycle of the heating appliance 10. Optionally, multiple separate and simultaneous temperature readings can be made (e.g., at each of multiple slots within a toaster or the like), and a lower of the two temperature readings can be reviewed upon a heating appliance 10 starting a heating cycle. As shown, the currently sensed temperature at point 326 is approximately 160° C. and decreasing, i.e., downsloping. Thus, a time derivative of the temperature curve 324 is negative, i.e., the time derivative is a value of less than zero.

At point 326, the temperature value is preferably first compared to the threshold temperature (x_{T}) for a “hot-hot” start. In the shown example, the temperature at 326 is approximately 160° C., and as shown the temperature is also decreasing over time, showing a negative derivative value at point 326 indicates that the heating appliance 10 is therefore both above the threshold temperature (x_{T}) and also cooling over time. Based on the above, the controller can select a time-based heating sub-equation and corresponding cycle that uses the determined cooling down time-based function above the threshold temperature (x_{T}). Therefore, the controller can select the time-based only function 312 in accordance with the determination of the slope.

FIG. 45 is an example of another temperature vs. time function where a heating appliance is heating as determined at a sensor. FIG. 45, in contrast to FIG. 44, shows an example where two temperature readings are made (curves 334 and 332) and where the sensed temperatures are both rising, e.g., after the heating appliance 10 has reached the target end temperature of a previous heating cycle. As shown, in some examples the sensed temperature continues to rise after a heating cycle is complete, in which case a sub-equation for time-based heating determines whether there is an upsloping temperature vs. time curve, and thus a positive sign to the time derivative at a point 336 as shown. FIG. 45 can show sensed temperature characteristics for example, immediately following a heating cycle initiated as shown in FIG. 44.

As shown, two temperature readings 330 and 332 are optionally read, and the lower of the two temperature readings at point 336 can be reviewed upon a heating appliance 10 starting a heating cycle. As shown, the lower sensed temperature value of curve 334 at point 336 is selected. As shown, the temperature at point 336 is instead upsloping at the point in time 336. In other words, the temperature curve 334 is upsloping at point 336. Prior to determining the slope of curve 334 at point 336, the controller determines that the heating appliance 10 is above the threshold temperature (x_{T}), indicating a “hot-hot” start, and the controller then also determines that the temperature is also increasing over time. As shown in FIG. 45, the time-based heating cycle would then use the sub-equation for the heating up time-based function. Therefore, the controller can select the respective time-based sub-equation in accordance with the determination of the sensed temperature above the threshold temperature (x_{T}) and the sign of the slope at the point in time.

Although the above examples utilized sub-equations based on time-derivatives and slopes for the time-only portion of the relevant piece-wise functions, it is also contemplated that the linear and/or quadratic portions of the piece-wise functions contemplated herein could be modified with sub-equations in a similar fashion. For example, a y-intercept value could be shifted for linear and/or quadratic equations based on a time- or other derivative of the sensed data, or the equations could have altered or transformed shape in the respective sub-equations. Various test data can be used to determine how the thermal inertia or the like affects any heating process results and variables for the quadratic and linear portions of the piece-wise functions discussed herein.

Although some examples herein use a pop-up electrical toaster as an example heating appliance, other heating appliances are also contemplated herein, including but not limited to: toaster ovens, grills, griddles, and container cookers. Container cookers contemplated include pressure cookers, air fryers, convection ovens, rice cookers, slow cookers, sous-vide cookers, etc. As some examples of heating appliances contemplated herein, Applicant hereby incorporates by reference in their entireties the disclosures of the following: pending U.S. patent application with Ser. No. 17/193,460 (US20210274968A1); PCT application PCT/US2020/052751 (WO2021188150A1) and PCT application PCT/US2019/054504 (WO2020072777A1).

The item, such as food item 30, to be heated as described herein is not limited to heating and toasting breads and the like. The food item 30 can include any suitable food item that can be heated, cooked, crisped, baked, etc. Some additional examples of the food item 30 include various meats, vegetables, pastries, pastas, sauces, soups, stews, casseroles, mixtures of the preceding or any other type of food or beverage. Although shade level is used throughout as an example of a desired and target parameter level and condition, other parameter levels and target levels for heating the food item 30 are also contemplated. In some examples, the target shade level can be replaced with a doneness level, a crispiness level, a color quality, an internal meat temperature, or any other suitable parameter. The item to be heated can be any heatable item or product.

What is claimed is:

1. A heating appliance comprising:
a heat source supported by a housing, the heat source operatively connected to a power supply;
a food guide element operatively supported by the housing, the food guide element comprising at least one guide wire positioned in a first orientation; and
a sensor attached to the guide wire such that the sensor at least partially overlaps a surface of the guide wire.

2. The heating appliance of claim 1, wherein the sensor is attached to the guide wire in either the same, first orientation or in a second orientation that is at least partially perpendicular to the first orientation, and wherein the first orientation is a vertical orientation or a horizontal orientation.

3. The heating appliance of claim 1, further comprising at least one clip configured to attach the sensor to the guide wire, wherein the guide wire comprises at least one protrusion for alignment and positioning of the sensor when attached to the guide wire.

4. The heating appliance of claim 1, wherein the sensor is generally cylindrical, and wherein when the sensor is attached to the guide wire, the sensor directly contacts the guide wire along a length.

5. The heating appliance of claim 1, wherein the heating appliance is a toaster comprising a carriage that is vertically movable relative to the housing and at least partially vertically supports a food item to be heated, wherein the carriage, in response to a lever being depressed, initiates a heating cycle, wherein the guide assembly comprises plural horizontally-opposed bread guides, and wherein the plural bread guides are horizontally movable in response to the lever being depressed.

6. The heating appliance of claim 1, wherein the heating appliance is a toaster oven, and wherein the food guide element comprises a horizontal tray or grille.

7. The heating appliance of claim 1, wherein the heating appliance is a toaster, and wherein the housing and the guide assembly together define an open slot configured to receive a food item.

8. The heating appliance of claim 1, wherein the sensor is a negative temperature coefficient of resistance thermal sensor or an infrared temperature sensor, and wherein the sensor is configured to be in a closely-spaced relationship of a first distance to a food item supported by the guide assembly during operation.

9. The heating appliance of claim 1, wherein the heat source comprises at least one resistive heating element operatively connected to the power supply.

10. A method of controlling a heating appliance, the heating appliance including a housing, a food support operatively connected with a housing, a heating source, and a controller, the method comprising:
receiving a level selection at the controller;
reading a starting parameter at an initiation of a heating process and providing a signal to the controller;
accessing a memory at the controller, the memory comprising a matrix of heating parameters;
selecting a first group of equations of the matrix at the controller based on the selected level, the first group of equations comprising at least a first equation and a second equation corresponding to first and second starting parameter ranges;
identifying an equation of the first group of equations of the matrix at the controller, the matrix having a corresponding starting parameter range based on the starting parameter; and
performing the heating process according to the identified equation.

11. The method of claim 10, wherein the level is a shade level, a doneness of a food product, a crispiness level, or a crunchiness level.

12. The method of claim 10, wherein the level corresponds to an external temperature level of a food product, and wherein the starting parameter is a starting internal temperature of the heating appliance.

13. The method of claim 10, wherein the first equation corresponds to a quadratic equation.

14. The method of claim 13, wherein the second equation corresponds to a linear equation.

15. The method of claim 10, wherein the first group of equations further comprises a third equation corresponding to a threshold maximum heat level.

16. The method of claim 15, wherein the third equation is only time-based, and wherein the third equation uses a time value to determine an end condition.

17. The method of claim 10, wherein the matrix has a first dimension according to a total number of possible level selections.

18. The method of claim 17, wherein the matrix has a second dimension according to a total number of individual portions of a piece-wise function.

19. The method of claim 18, wherein the matrix has a third dimension according to a time-derivative of a temperature reading at a sensor associated with the heating appliance.

20. The method of claim 19, wherein the time-derivative of the temperature reading comprises a derivative sign corresponding to an increasing or decreasing slope of the time-derivative of the temperature reading at a point in time associated with the initiation of the heating process.

21. The method of claim 20, wherein the matrix has a third dimension according to a total number of derivative-based sub-equations.

22. The method of claim 18, wherein the piece-wise function has at least three portions, comprising one of more of the following:
a quadratic portion;
a linear portion; and
a time-based portion.

23. The method of claim 22, further comprising determining a time-derivative of temperature at a sensor associated with the heating appliance, wherein the identifying the equation further comprises selecting a sub-equation of at least one of the quadratic portion, the linear portion, and the time-based portion based on a slope value of the time-derivative of temperature, wherein the time-derivative of temperature is associated with a point in time associated with the initiation of the heating process.

24. The method of claim 23, wherein based on the slope value of the time-derivative of temperature, either a first sub-equation is selected for a positive slope sign or a second sub-equation is selected for a negative slope sign.

25. The method of claim 24, wherein the heating process is performed according to at least one of the quadratic portion, the linear portion, and the time-based portion based on the selected first or second sub-equation, further based on a starting temperature, the level selection, and the slope sign of the derivative.

26. The method of claim 25, wherein the heating process is performed according to the time-based portion, and wherein the level selection is associated with a target temperature.

27. The method of claim 22, wherein the quadratic portion, the linear portion, and the time-based portion each correspond to a non-overlapping range of starting parameters.

28. The method of claim 22, wherein the controller is configured to selectively use the quadratic portion to calculate an ending parameter based on the starting parameter and the level selection; the linear portion is used to calculate an ending parameter based on the starting parameter and the level selection; and/or the time-based portion is used to calculate an ending time based on the starting parameter and the level selection.

29. The method of claim 28, wherein the calculated ending parameter is a calculated target temperature of a food item to be heated within the heating appliance.

30. A heating appliance, comprising:
a hardware processor operatively coupled to a memory, wherein the hardware processor is configured to execute steps, including:
receiving a level selection;
receiving an indication that a heating process is starting;
reading a starting parameter;
accessing a memory comprising a matrix of heating parameters;
selecting a first group of equations of the matrix based on the selected level, the first group of equations comprising at least a first equation and a second equation corresponding to first and second starting parameter ranges;
identifying an equation of the first group of equations of the matrix having a corresponding starting parameter range based on the starting parameter; and
performing the heating process according to the identified one equation.
